(19) United States
(12) Patent Application Publication
(10) Pub. No.: US 2022/0410315 A1
(43) Pub. Date: Dec. 29, 2022

(54) MULTI-AXIS MACHINE TOOL, METHODS OF CONTROLLING THE SAME AND RELATED ARRANGEMENTS

(71) Applicant: ELECTRO SCIENTIFIC INDUSTRIES, INC., Beaverton, OR (US)

(72) Inventor: Guang Lu, Beaverton, OR (US)

(21) Appl. No.: 17/895,403

(22) Filed: Aug. 25, 2022

Related U.S. Application Data
(63) Continuation of application No. 16/499,511, filed on Sep. 30, 2019.
(60) Provisional application No. 62/511,072, filed on May 25, 2017.
(60) Provisional application No. 62/502,311, filed on May 5, 2017.

(51) Int. Cl. B23K 26/08; B23K 26/082; B23K 26/12

(52) U.S. Cl. CPC B23K 26/0884; B23K 26/082; B23K 26/128

(57) ABSTRACT

Varied embodiments of a laser-based machine tool, and techniques for controlling the same are provided. Some embodiments relate to techniques to facilitate uniform and reproducible processing of workpieces. Other embodiments relate to a zoom lens having a quickly-variable focal length. Still other embodiments relate to various features of a laser-based multi-axis machine tool that can facilitate efficient delivery of laser energy to a scan head, that can address thermomechanical issues that may arise during workpiece processing, etc. Another embodiment relates to techniques for minimizing or preventing undesired accumulation of particulate matter on workpiece surfaces during processing. A number of other embodiments and arrangements are also detailed.

### CROSS-REFERENCE TO RELATED APPLICATIONS

This is a continuation application of U.S. application Ser. No. 16/499,511, filed Sep. 30, 2019, which is a National Phase entry of PCT/US2018/030152 application, filed Apr. 30, 2018, which claims the benefit of U.S. Provisional Application No. 62/511,072, filed May 25, 2017, and of U.S. Provisional Application No. 62/502,311, filed May 5, 2017, each of which is incorporated by reference in its entirety.

### TECHNICAL FIELD

Embodiments of the present invention relate generally to systems and methods for enabling automated motion control, in which the position or movement of a tool in a multi-axis machine tool is controlled using one or more actuators.

### BACKGROUND

Motion control is an important aspect in robotic systems (e.g., involving articulated robot configurations, Cartesian robot configurations, cylindrical robot configurations, polar robot configurations, delta robot configurations, or the like or combinations thereof), numerical control (NC) machines, computerized NC (CNC) machines, and the like (generically and collectively referred to herein as “machine tools,” which can be adapted to process a workpiece). These machine tools typically include one or more controllers, one or more actuators, one or more sensors (each provided as a discrete devices, or embedded in an actuator), a tool holder or tool head, and various data communication subsystems, operator interfaces, and the like. Depending on the type and number of actuators included, a machine tool may be provided as a “multi-axis” machine tool, having multiple, independently-controllable axes of motion.

The continuing market need for higher productivity in machining and other automation applications has led to the increasing use of machine tools with various types of actuators, sensors and associated controllers. In some cases, a multi-axis machine tool (also referred to herein as a “hybrid multi-axis machine tool”) may be equipped with multiple actuators capable of imparting movement along the same direction, but at different bandwidths. Generally, one actuator (e.g., a first actuator) can be characterized as having a higher bandwidth than another actuator (e.g., a second actuator) if the first actuator can impart movement in response to a command signal having a given spectral or frequency content more accurately than the second actuator can impart movement in response to the same command signal. Often, however, the range of motion over which the first actuator can impart movement will be less than range of motion over which the second actuator can impart movement.

Deciding which components of motion should be allocated between relatively-high and relatively-low bandwidth actuators of a hybrid multi-axis machine tool is not an easy task. A common strategy involves operating one or more relatively-low bandwidth actuators to move a workpiece to be processed and/or to move one or more relatively-high bandwidth actuators to a desired location or “zone” where the workpiece is to be processed, and then hold the position of relatively-low bandwidth actuator(s) constant while operating the relatively-high bandwidth actuator(s) during processing of the workpiece. Thereafter, the relatively-low bandwidth actuator(s) are operated to move the workpiece and/or the relatively-high bandwidth actuator(s) to another “zone” where the workpiece is to be processed. This “zone-by-zone” approach (also referred to as a “step-and-repeat” approach) to motion control is undesirable because it significantly limits throughput and flexibility of the hybrid multi-axis machine tool. It can also be difficult to appropriately or beneficially define the various “zones” of the workpiece where the relatively-high bandwidth actuator(s) can be operated.

U.S. Pat. No. 8,392,002, which is incorporated herein by reference in its entirety, is understood to address the above-mentioned problems associated with implementing the “zone-by-zone” approach by processing a part description program to decompose a tool tip trajectory (on the basis of frequency) defined in the part description program into different sets of position control data appropriate for the relatively-low and relatively-high bandwidth actuators of a hybrid multi-axis machine tool. However, and as acknowledged in U.S. Pat. No. 8,392,002, when the hybrid multi-axis machine tool is configured to hold a workpiece using a 5-axis CNC manipulator with two rotary axes riding on a 3-axis Cartesian stage, and includes relatively-high bandwidth actuators to move a tool tip in the 3 Cartesian axes, use of the frequency-based decomposition approach can result in errors in the angles associated with the rotary axes.

### SUMMARY

One embodiment can be broadly characterized as a laser-based multi-axis machine tool for processing a workpiece, wherein the tool includes: a laser source configured to generate laser light propagatable along a propagation path to illuminate the workpiece at a spot; a workpiece positioning assembly operative to move the workpiece; a tool tip positioning assembly operative to move the spot; and a controller operatively coupled to the workpiece positioning assembly and the tool tip positioning assembly, wherein the controller is operative to control an operation of at least one selected from the group consisting of the workpiece positioning assembly and the tool tip positioning assembly to cause relative movement between the workpiece and the spot along a tool path in at least three axes, wherein the controller includes a error correction system operative to detect and compensate for deviations of the tool path from a desired trajectory.

Another embodiment can be broadly characterized as a controller operative to control an operation of at least one selected from the group consisting of a workpiece positioning assembly and a tool tip positioning assembly to cause relative movement between a workpiece and a spot along a tool path in at least three axes, wherein the controller includes a error correction system operative to detect and compensate for deviations of the tool path from a desired trajectory.

Another embodiment can be broadly characterized as a non-transitory computer-readable medium for use with a controller for a laser system for machining a workpiece, wherein the non-transitory computer-readable medium has instructions stored thereon which, when executed by the controller, cause the controller to control an operation of at least one selected from the group consisting of a workpiece positioning assembly and a tool tip positioning assembly to cause relative movement between a workpiece and a spot along a tool path in at least three axes, wherein the controller includes a error correction system operative to detect and compensate for deviations of the tool path from a desired trajectory.

### BRIEF DESCRIPTION OF THE DRAWINGS

FIG. 1 is a block diagram schematically illustrating a control system for controlling a multi-axis machine tool according to one embodiment.

FIGS. 2A and 2B schematically illustrate workpiece positioning assemblies according to some embodiments of the present invention.

FIG. 3 schematically illustrates a tool tip positioning assembly according to one embodiment of the present invention.

FIG. 4 is a block diagram schematically illustrating a control system for controlling a multi-axis machine tool according to another embodiment.

FIGS. 5 and 6 are block diagrams schematically illustrating pre-processing stages according to some embodiments of the present invention.

FIGS. 7 and 8 schematically illustrate exemplary positions and movements associated with a positioning assembly adjustment technique, according to some embodiments of the present invention.

FIGS. 9, 10 and 11 schematically illustrate an optical arrangement including a zoom lens according to one embodiment of the present invention.

FIG. 12 is a graph illustrating results of an experiment performed using a zoom lens configured as described with respect to FIGS. 9, 10 and 11.

FIGS. 13A and 13B are block diagrams schematically illustrating some embodiments of an error correction system for implementing an error correction technique.

FIG. 14 is a perspective view schematically illustrating a hybrid multi-axis machine tool according to one embodiment.

FIG. 15 is a partial side plan view schematically illustrating the hybrid multi-axis machine tool shown in FIG. 14, taken along line XV-XV′ in FIG. 14.

### DETAILED DESCRIPTION

Example embodiments are described herein with reference to the accompanying drawings. Unless otherwise expressly stated, in the drawings the sizes, positions, etc., of components, features, elements, etc., as well as any distances therebetween, are not necessarily to scale, but are exaggerated for clarity. In the drawings, like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

The terminology used herein is for the purpose of describing particular example embodiments only and is not intended to be limiting. Unless otherwise defined, all terms (including technical and scientific terms) used herein have the same meaning as commonly understood by one of ordinary skill in the art. As used herein, the singular forms “a,” “an” and “the” are intended to include the plural forms as well, unless the context clearly indicates otherwise. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one node could be termed a “first node” and similarly, another node could be termed a “second node”, or vice versa.

Unless indicated otherwise, the term “about,” “thereabout,” “approximately,” etc., means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Spatially relative terms, such as “below,” “beneath,” “lower,” “above,” and “upper,” and the like, may be used herein for ease of description to describe one element or feature's relationship to another element or feature, as illustrated in the FIGS. It should be recognized that the spatially relative terms are intended to encompass different orientations in addition to the orientation depicted in the FIGS. For example, if an object in the FIGS. is turned over, elements described as “below” or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly.

The section headings used herein are for organizational purposes only and, unless explicitly stated otherwise, are not to be construed as limiting the subject matter described. It will be appreciated that many different forms, embodiments and combinations are possible without deviating from the spirit and teachings of this disclosure and so this disclosure should not be construed as limited to the example embodiments set forth herein. Rather, these examples and embodiments are provided so that this disclosure will be thorough and complete, and will convey the scope of the disclosure to those skilled in the art.

### I. System Overview

Embodiments described herein can be generally characterized as pertaining to multi-axis machine tools that are configured to process workpieces, methods for controlling such multi-axis machine tools, and related arrangements. Examples of multi-axis machine tools that may be controlled according to embodiments described herein include routers, milling machines, plasma cutting machines, electrical discharge machining (EDM) systems, laser cutting machines, laser marking machines, laser drilling machines, laser engraving machines, remote laser welding robots, 3D printers, waterjet cutters, abrasive jet cutters, and the like. Thus, the multi-axis machine tool can be characterized as being configured to physically contact the workpiece with a mechanical structure such as a router bit, a drill bit, a tool bit, a grinding bit, a blade, etc., to remove, cut, polish, roughen, etc., one or more materials from which the workpiece is formed. Additionally, or alternatively, the multi-axis machine tool can be characterized as being configured to direct energy (e.g., in the form of laser light generated by a laser source, heat generated by a torch, an ion beam or an electron beam generated from an ion or electron source, or the like or any combination thereof), direct a stream or jet of matter (e.g., water, air, sand or other abrasive particles, paint, metallic powder, or the like or any combination thereof), or the like or any combination thereof, to remove, cut, drill, polish, roughen, heat, melt, vaporize, ablate, crack, mark, discolor, foam, paint or coat, decoat, clean, weld, scribe, engrave, or otherwise modify or alter one or more properties or characteristics (e.g., chemical composition, crystal structure, electronic structure, microstructure, nanostructure, density, viscosity, index of refraction, magnetic permeability, relative permittivity, exterior or interior visual appearance, texture, transmissivity to light of any wavelength, reflectivity of light of any wavelength, etc.) of one or more materials from which the workpiece is formed. Such materials may be present at an exterior surface of the workpiece prior to or during workpiece processing, or may be located within the workpiece (i.e., not present at an exterior surface of the workpiece) prior to or during workpiece processing. Exemplary features that may be formed on or within the workpiece as a result of processing may include one or more openings, slots, vias or other holes, grooves, channels, trenches, scribe lines, kerfs, recessed regions, conductive traces, ohmic contacts, resist patterns, human-perceptible or machine-readable indicia, or the like or any combination thereof. As used herein, human-perceptible or machine-readable indicia can include one or more regions in or on the workpiece that having one or more of the aforementioned properties or characteristics that differ from any corresponding characteristic(s) of any region of the workpiece that adjoins or is otherwise adjacent to the feature.

Regardless of how the workpiece is processed, any mechanism that is used to effect the processing of a workpiece (e.g., any of the aforementioned mechanical structures, any directed energy, directed streams or jets of matter, or the like, or any combination thereof) is herein referred to as a “tool.” Any tool such as any of the aforementioned mechanical structures can be also referred to herein as a “contact-type tool,” and any tool such as directed energy, a directed stream or jet of matter, etc., can be also referred to herein as a “contactless-type tool.” The multi-axis machine tool may include one or more tool subsystems (e.g., each associated with a different tool such as discussed above), which may be selectively activated or otherwise engaged to process the workpiece using a tool. For example, if the tool is provided as any of the aforementioned mechanical structures, the multi-axis machine tool may include a tool subsystem (e.g., a router, a drill, a mill, etc.) for rotating or otherwise moving the tool. If the tool is provided as directed energy, the multi-axis machine tool may include a tool subsystem such as a laser subsystem (e.g., if the directed energy is laser light), a torch subsystem (e.g., if the directed energy is heat), an EDM subsystem or other electron or ion beam source (e.g., if the directed energy is an electron beam, ion beam, etc.). If the tool is provided as a directed stream or jet of matter, the multi-axis machine tool may include a tool subsystem such as a waterjet cutter, an abrasive jet cutter, an air gun sprayer, an electrostatic spray painting system, etc.

The portion or portions of the tool that physically contact the workpiece or that otherwise interact with the workpiece (e.g., via absorption of heat or electromagnetic radiation within the workpiece, by conversion of kinetic energy of incident electrons or ions into heat within the workpiece, by workpiece erosion, etc.) are herein individually and collectively referred to as the “tool tip,” and any region of the workpiece that is ultimately processed by the tool (e.g., at the tool tip) is herein referred to as the “tooling region.” In embodiments in which the tool is a mechanical structure that is rotatable about an axis that intersects the workpiece (e.g., as with a router bit, a drill bit, etc.), or in which the tool is energy or a stream or jet of matter directed onto the workpiece along an axis (also referred to herein as a “tooling axis”) that intersects the workpiece, an angle of the tooling axis relative to the portion of the surface of the workpiece intersected by the tooling axis is herein referred to as a “tooling angle.”

The multi-axis machine tool includes one or more actuators to position the tool tip, to position the workpiece, to move the tool tip relative to the workpiece, to move the workpiece relative to the tool tip, or any combination thereof. Thus, the position of the tooling region on or within the workpiece can be changed upon imparting relative movement between the tool tip and the workpiece. Each actuator may be arranged or otherwise configured to position the tooling region or otherwise impart relative movement between the tooling region and the workpiece along at least one linear axis, along at least one rotary axis, or any combination thereof. As is known in the art, examples of linear axes include an X-axis, a Y-axis (orthogonal to the X-axis) and a Z-axis (orthogonal to the X- and Y-axes), and examples of rotary axes include an A-axis (i.e., defining rotation about an axis parallel to the X-axis), a B-axis (i.e., defining rotation about an axis parallel to the Y-axis) and a C-axis (i.e., defining rotation about an axis parallel to the Z-axis).

Actuators arranged or configured to position the tooling region or otherwise impart relative movement between the tooling region and the workpiece along a linear axis may be generally referred to as “linear actuators.” Actuators arranged or configured to position the tooling region or otherwise impart relative movement between the tooling region and the workpiece along a rotary axis may be generally referred to as “rotary actuators.” Examples of linear actuators that may be included within the multi-axis machine tool include one or more X-axis actuators (i.e., actuators arranged or configured to impart motion along the X-axis), one or more Y-axis actuators (i.e., actuators arranged or configured to impart motion along the Y-axis) and one or more Z-axis actuators (i.e., actuators arranged or configured to impart motion along the Z-axis), or any combination thereof. Examples of rotary actuators that may be included within the multi-axis machine tool include one or more A-axis actuators (i.e., actuators arranged or configured to impart motion along the A-axis), one or more B-axis actuators (i.e., actuators arranged or configured to impart motion along the B-axis) and one or more C-axis actuators (i.e., actuators arranged or configured to impart motion along the C-axis), or any combination thereof. If an actuator is arranged or configured to position the tooling region or otherwise impart relative movement between the tooling region and the workpiece along an axis, then that actuator can be characterized as being “associated” with that axis.

The multi-axis machine can be characterized as a “spectrally-complementary” multi-axis machine tool, or as a “non-spectrally-complementary” multi-axis machine tool. A spectrally-complementary multi-axis machine tool includes one or more sets of redundant actuators capable of imparting movement along the same axis, but at different bandwidths. A non-spectrally-complementary multi-axis machine tool does not include any sets of redundant actuators.

The multi-axis machine tool may be characterized as an “axially-complementary” multi-axis machine tool or as a “non-axially complementary” multi-axis machine tool. An axially-complementary multi-axis machine tool has a set of axially-complementary actuators including at least one rotary actuator configured to position the tool tip and/or the workpiece, or impart movement to the tool tip and/or the workpiece, along at least one rotary axis, and at least one linear actuator configured to position the tool tip and/or the workpiece, or impart movement to the tool tip and/or the workpiece, along at least one linear axis. In an axially-complementary multi-axis machine tool, at least one rotary axis about which the tool and/or workpiece is rotatable is not parallel to at least one linear axis along which the tool and/or workpiece can be translated. For example, a set of axially-complementary actuators may include a rotary actuator configured to impart motion along the B-axis, and at least one linear actuator configured to impart motion along the X-axis, along the Z-axis, or along the X- and Z-axes. In another example, a set of axially-complementary actuators may include a rotary actuator configured to impart motion along the B-axis, and at least one rotary actuator configured to impart motion along the C-axis, and at least one linear actuator configured to impart motion along the X-axis, along the Z-axis, or along the X- and Z-axes. Generally, however, a set of axially-complementary actuators can be characterized as being non-redundant with one another. A non-axially-complementary multi-axis machine tool does not include a set of axially-complementary actuators. It should be recognized that either a spectrally-complementary multi-axis machine tool or a non-spectrally-complementary multi-axis machine tool can be configured as an axially-complementary multi-axis machine tool or as a non-axially-complementary multi-axis machine tool.

Generally, actuators of the multi-axis machine tool are driven in response to actuator commands that are obtained, or otherwise derived from, a computer file (e.g., a G-code computer file) or a computer program. In an embodiment in which an actuator command is derived from a computer file or a computer program, such actuator command may be interpolated from a desired trajectory (or a component of the desired trajectory) that is defined in a computer file or by a computer program. The trajectory can define a sequence of tool tip and/or workpiece positions and/or movements (e.g., along one or more spatial axes) such as lines, arcs, splines, or the like or any combination thereof, that describe how the tooling region is to be positioned, oriented, moved, etc., during processing of the workpiece by the multi-axis machine tool. In some embodiments, an actuator command can correspond to a sequence of tool tip and/or workpiece positions and/or movements.

Generally, different actuator commands can correspond to different axial positions or movements, whereby a “linear actuator command” is an actuator command corresponding to a linear component of position or movement and a “rotary actuator command” is an actuator command corresponding to a rotational component of position or movement. In particular, an “X-axis actuator command” can correspond to a linear component of position or movement along an X-axis, a “Y-axis actuator command” can correspond to a linear component of position or movement along a Y-axis (where the Y-axis is orthogonal to the X-axis), a “Z-axis actuator command” can correspond to a linear component of position or movement along a Z-axis (where the Z-axis is orthogonal to the Y-axis), an “A-axis actuator command” can correspond to a rotational component of position or movement along an “A-axis” (A-axis rotational motion characterizes rotation about an axis parallel to the X-axis), a “B-axis actuator command” can correspond to a rotational component of position or movement along a “B-axis” (B-axis rotational motion characterizes rotation about an axis parallel to the Y-axis), and a “C-axis actuator command” can correspond to a rotational component of position or movement along a “C-axis” (C-axis rotational motion characterizes rotation about an axis parallel to the Z-axis). If an actuator command corresponds to a component of position or movement along an axis, then that actuator command can be characterized as being “associated” with that axis.

As used herein, the term “actuator command” refers to an electrical signal characterized by an amplitude that changes over time and can, thus, be characterized in terms of what is known in the art as “frequency content.” Typically, an actuator of the multi-axis machine tool will be characterized by one or more constraints (e.g., a velocity constraint, an acceleration constraint, a jerk constraint, etc.) that limits the bandwidth of the actuator. As used herein, the “bandwidth” of an actuator refers to the ability of actuator to accurately or reliably react or respond to an actuator command (or a portion of the actuator command) having frequency content exceeding a threshold frequency associated with the actuator. It should be recognized that the threshold frequency for any particular actuator can vary depending upon the type of the particular actuator, the specific construction of the particular actuator, the mass of the particular actuator, the mass of any objects attached to or movable by the particular actuator, and the like. For example, threshold frequencies for types of actuators such as servo motors, stepper motors, hydraulic cylinders, etc. may be the same or different from one another (as is known in the art), but are generally less than threshold frequencies for types of actuators such as galvanometers, voice-coil motors, piezoelectric actuators, electron beam magnetic deflectors, magnetostrictive actuators, etc. (which, as is known in the art, may be the same as, or different from, each other). Depending on the manner in which they are configured, a rotary actuator can have a threshold frequency that is less than that of a linear actuator.

Ultimately, an actuator command is output to a corresponding actuator of the multi-axis machine tool, wherein each actuator is operative to position or move the tool tip and/or the workpiece along an axis that corresponds to the component of position or movement associated with the received actuator command. For example, an X-axis actuator command will ultimately be output to a linear actuator arranged or configured to position or move the tool tip and/or workpiece along the X-axis, a B-axis actuator command will ultimately be output to a rotary actuator arranged or configured to position or move the tool tip and/or workpiece along the B-axis (i.e., to rotate the tool tip and/or workpiece about the Y-axis), etc. If a trajectory describes a movement that can be decomposed into two or more components of movement (e.g., concurrent motion in two or more of the X-, Y-, Z-, A-, B- or C-axes), then such components of motion can be characterized as being “associated” with one another. Actuator commands that correspond to associated components of motion described by a trajectory can, likewise, be characterized as being “associated” with one another. When actuator commands are output to the actuators in a synchronized or otherwise coordinated manner, the actuators essentially react or respond by imparting relative movement between the tool tip and the workpiece in manner that moves the tooling region along a path (also referred to as a “tool path”) that matches or otherwise corresponds to the desired trajectory.

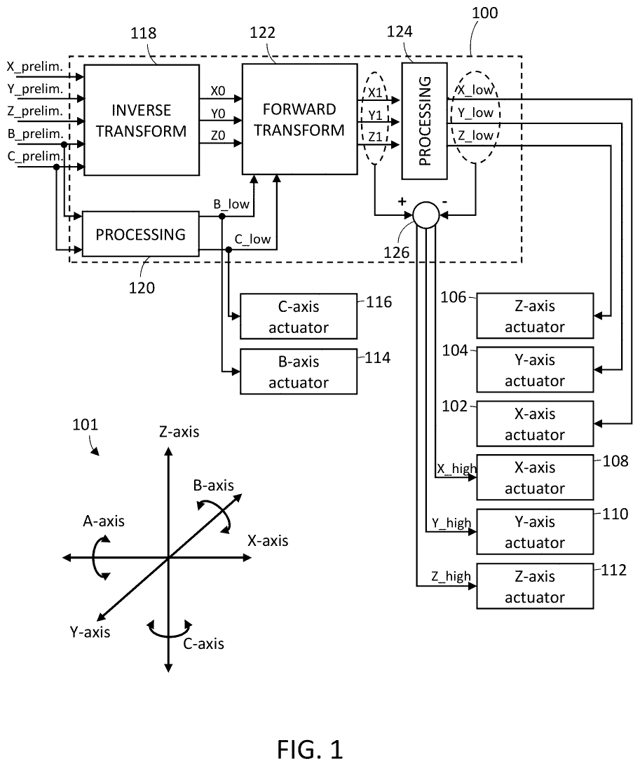

Some general embodiments concerning the generation and use of certain sets of actuator commands (i.e., “spectrally-complementary actuator commands” and “axially-complementary actuator commands”) are discussed in the Sections below. While the two sets of actuator commands are generally described as being separately generated and used, it should be recognized that the two sets of actuator commands can be generated and used together in a combined manner. Some examples of combined generation and use of the two sets of actuator commands will be described in greater detail with respect to FIGS. 1 to 4.

### A. Embodiments Concerning Actuator Commands for Spectrally-Complementary Multi-Axis Machine Tools, Generally

In an embodiment in which the multi-axis machine tool is a hybrid multi-axis machine tool, a set of spectrally-complementary actuator commands may be output to a corresponding set of redundant actuators. Within a set of spectrally-complementary actuator commands, the frequency content of one of the actuator commands (e.g., a first actuator command) will be higher than the frequency content of another one of the actuator commands (e.g., a second actuator command), and the first actuator command will ultimately be output to a relatively-high bandwidth actuator in the set of redundant actuators (e.g., capable of accurately or reliably reacting or responding to the first spectrally-complementary actuator commands) while the second actuator command will ultimately be output to a relatively-low bandwidth actuator in the set of redundant actuators (e.g., capable of more accurately or reliably reacting or responding to the second frequency command than to the first frequency command).

The set of spectrally-complementary actuator commands can be generated in any suitable manner. For example, the set of spectrally-complementary actuator commands can be generated by processing an actuator command (e.g., describing a position or movement along a single axis, such as the X-, Y-, Z-, A-, B- or C-axis, or the like) obtained or otherwise derived from a computer file or a computer program as discussed herein. In this case, such an actuator command is also referred to as a “preliminary actuator command,” and has a frequency content spanning a preliminary range of frequencies. The preliminary range of frequencies may include non-negligible frequency content at one or more frequencies that exceeds the threshold frequency of at least one actuator in the set of redundant actuators. The preliminary actuator command may be processed to create a set of spectrally-complementary actuator commands.

Generally, each spectrally-complementary actuator command has a frequency content spanning a sub-range of frequencies that is less than and within the preliminary range. Specifically, the frequency content of each actuator command in the set of spectrally-complementary actuator commands includes non-negligible frequency content at one or more frequencies that does not exceed the threshold frequency of a corresponding actuator in the set of redundant actuators. For example, within a set of spectrally-complementary actuator commands, the frequency content of one of the spectrally-complementary actuator commands (e.g., a first spectrally-complementary actuator command to be ultimately output to a first actuator in the set of redundant actuators) will span a first sub-range of frequencies and the frequency content of another of the spectrally-complementary actuator commands (e.g., a second spectrally-complementary actuator command to be ultimately output to a second actuator in the set of redundant actuators) will span a second sub-range of frequencies. In one embodiment, an average frequency of the first sub-range may be less than, greater than or equal to an average frequency of the second sub-range. The extent of the first sub-range may be greater than, less than, or equal to the extent of the second sub-range. The first sub-range may overlap, adjoin, or be spaced apart from the second sub-range.

In some embodiments, processing of the preliminary actuator command can include applying one or more suitable filters to the preliminary actuator command (or another command derived from the preliminary actuator command), by modifying the preliminary actuator command (or another command derived from the preliminary actuator command) according to one or more suitable algorithms, by decimating the preliminary actuator command (or another command derived from the preliminary actuator command), by applying one or more low-order interpolation to the preliminary actuator command (or another command derived from the preliminary actuator command), or the like or any combination thereof. Examples of suitable filters include digital filters, low pass filters, Butterworth filters, or the like or any combination thereof. Examples of suitable algorithms include an auto-regressive moving-average algorithm, or the like. In some embodiments, the set of spectrally-complementary actuator commands can be generated as described in one or more of U.S. Pat. Nos. 5,751,585, 6,706,999, and 8,392,002, each of which is incorporated herein by reference in its entirety. It should be recognized, however, that the set of spectrally-complementary actuator commands can be generated according to techniques described in one or more of U.S. Pat. Nos. 5,638,267, 5,988,411, 9,261,872 or in one or more of U.S. Patent App. Pub. Nos. 2014/0330424, 2015/0158121, 2015/0241865, each of which is incorporated herein by reference in its entirety.

Although the set of spectrally-complementary processed actuator commands has been described as including only two spectrally-complementary actuator commands, it should be recognized that the set of spectrally-complementary actuator commands can include any number of spectrally-complementary actuator commands (e.g., 3, 4, 5, 6, 7, 8, etc.). The number of spectrally-complementary actuator commands in a set of spectrally-complementary actuator commands corresponding to a common axis can be equal to the number of redundant actuators in the set of redundant actuators capable of positioning or imparting movement along the common axis.

### B. Embodiments Concerning Actuator Commands for Axially-Complementary Multi-Axis Machine Tools, Generally

Sometimes, a rotary actuator command (e.g., a B-axis actuator command) to be issued to a rotary actuator (e.g., a B-axis actuator) contains non-negligible frequency content that exceeds the threshold frequency of the rotary actuator. Accordingly, and in an embodiment in which the multi-axis machine tool is an axially-complementary multi-axis machine tool, a set of axially-complementary actuator commands may be output to a set of axially-complementary actuators, which includes the rotary actuator, to compensate for the limited bandwidth capability of the rotary actuator. For example, a set of axially-complementary actuator commands may include an axially-complementary rotary actuator command having a frequency content that does not exceed the threshold frequency of the rotary actuator, and at least one axially-complementary linear actuator command. The axially-complementary rotary actuator command may be output to the rotary actuator, and the at least one axially-complementary linear actuator command may be output to one or more corresponding linear actuators (i.e., that are in the same set of axially-complementary actuators as the rotary actuator).

The set of axially-complementary actuator commands can be generated in any suitable manner. For example, the set of axially-complementary actuator commands can be generated by processing a rotary actuator command (e.g., describing a position or movement along a single rotary axis, such as the B-axis) obtained or otherwise derived from a computer file or a computer program as discussed herein. In this case, such a rotary actuator command is also referred to as a “a rotary actuator command,” and has a frequency content spanning a preliminary range of frequencies. The preliminary range of frequencies may include non-negligible frequency content at one or more frequencies that exceeds the threshold frequency of the rotary actuator. The preliminary rotary actuator command may be processed to create a set of axially-complementary actuator commands that includes at least one axially-complementary rotary actuator command and at least one axially-complementary linear actuator command.

In some embodiments, the processing of the preliminary rotary actuator command can include applying one or more suitable filters to the preliminary rotary actuator command (or another command derived from the preliminary rotary actuator command), by modifying the preliminary rotary actuator command (or another command derived from the preliminary rotary actuator command) according to one or more suitable algorithms, by decimating the preliminary rotary actuator command (or another command derived from the preliminary rotary actuator command), by applying one or more low-order interpolation to the preliminary rotary actuator command (or another command derived from the preliminary rotary actuator command), or the like or any combination thereof. Examples of suitable filters include digital filters, low pass filters, Butterworth filters, or the like or any combination thereof. Examples of suitable algorithms include an auto-regressive moving-average algorithm, or the like.

### II. Controlling a Multi-Axis Machine Tool Having Axially-Complementary Actuators and Redundant Linear Actuators

FIG. 1 is a block diagram schematically illustrating a control system 100 for controlling a multi-axis machine tool which, according to one embodiment, includes a relatively-low bandwidth X-axis actuator 102, a relatively-low bandwidth Y-axis actuator 104, a relatively-low bandwidth Z-axis actuator 106, a relatively-high bandwidth X-axis actuator 108, a relatively-high bandwidth Y-axis actuator 110, a relatively-high bandwidth Z-axis actuator 112, a B-axis actuator 114 and a C-axis actuator 116. A legend illustrating the spatial relationships between the axes discussed herein is illustrated at 101. In one embodiment, the relatively-high bandwidth X-axis actuator 108, relatively-high bandwidth Y-axis actuator 110 and relatively-high bandwidth Z-axis actuator 112 each have a bandwidth that is greater than or equal to the bandwidth of the B-axis actuator 114 and the C-axis actuator 116. In another embodiment, however, one or more of the relatively-high bandwidth X-axis actuator 108, relatively-high bandwidth Y-axis actuator 110 and relatively-high bandwidth Z-axis actuator 112 may have a bandwidth that is less than the bandwidth of the B-axis actuator 114 and the C-axis actuator 116.

The relatively-low and relatively-high bandwidth X-axis actuators 102 and 108, respectively, constitute a set of redundant actuators (i.e., a set of redundant X-axis actuators). Likewise, a set of redundant actuators is constituted by each pair of the relatively-low and relatively-high bandwidth Y-axis actuators 104 and 110, respectively (i.e., a set of redundant Y-axis actuators), and the relatively-low and relatively-high bandwidth Z-axis actuators 106 and 112, respectively (i.e., a set of redundant Z-axis actuators). Although the illustrated embodiment describes a multi-axis machine tool having a set of redundant linear actuators constituted by only two linear actuators, it will be appreciated that the multi-axis machine tool may be further equipped with one or more additional linear actuators arranged or configured to impart movement along any of the X-, Y- and Z-axes, so that any set of redundant actuators may include three or more linear actuators.

In one embodiment, no actuator within any set of redundant actuators is attached to, or moved by another actuator in the same set of redundant actuators. For example, the relatively-high bandwidth X-axis actuator 108 is not attached to, nor is it moved by, the relatively-low bandwidth X-axis actuator 102. In another embodiment, however, at least one actuator within a set of redundant actuators may be attached to, and moved by, another actuator in the same set of redundant actuators. In such an embodiment, a relatively-low bandwidth actuator in a set of redundant actuators may move, or may be moved by, a relatively-high bandwidth actuator in the set of redundant actuators.

In one embodiment, the B-axis actuator 114, considered with one or more actuators within the set of redundant X-axis actuators and/or one or more within the set of redundant Z-axis actuators, constitutes a set of axially-complementary actuators. Likewise, the C-axis actuator 116, considered with one or more actuators within the set of redundant X-axis actuators and/or one or more within the set of redundant Y-axis actuators, constitutes a set of axially-complementary actuators Further, the B-axis actuator 114 and the C-axis actuator 116, considered with one or more actuators within the set of redundant X-axis actuators, one or more actuators within the set of redundant Y-axis actuators and/or one or more within the set of redundant Z-axis actuators, constitutes a set of axially-complementary actuators.

In the illustrated embodiment, the multi-axis machine tool does not include any A-axis actuator. It should be recognized, however, that the multi-axis machine tool may include an A-axis actuator, and that the embodiments discussed herein may be adapted to control the A-axis actuator as discussed herein.

### A. Embodiments Concerning the Workpiece Positioning Assembly

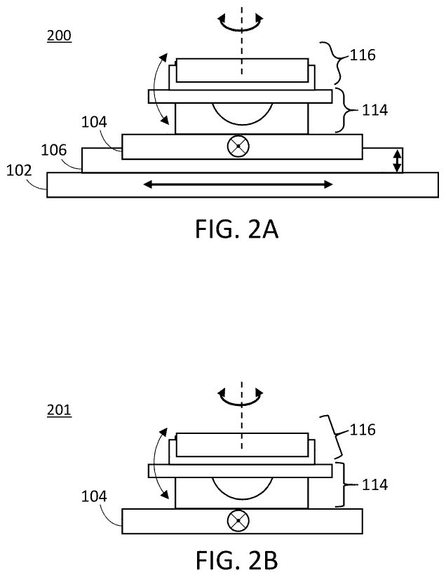

In one embodiment, the relatively-low bandwidth X-axis actuator 102, relatively-low bandwidth Y-axis actuator 104, relatively-low bandwidth Z-axis actuator 106, B-axis actuator 114 and C-axis actuator 116 may be incorporated as parts of a type of positioning assembly referred to herein as a “workpiece positioning assembly.” The workpiece positioning assembly is configured to position or otherwise move a workpiece along the X-axis, Y-axis, Z-axis, B-axis, C-axis, or any combination thereof, either simultaneously or non-simultaneously. For example, each of the relatively-low bandwidth X-axis actuator 102, relatively-low bandwidth Y-axis actuator 104, relatively-low bandwidth Z-axis actuator 106, B-axis actuator 114 and C-axis actuator 116 may include one or more components (e.g., stages, fixtures, chucks, rails, bearings, brackets, clamps, straps, bolts, screws, pins, retaining rings, ties, etc., not shown) to permit one or more of such actuators to be mounted to or otherwise mechanically coupled to one another. In this case, the relatively-low bandwidth Z-axis actuator 106 may be mounted on the relatively-low bandwidth X-axis actuator 102 (e.g., so as to be movable by the relatively-low bandwidth X-axis actuator 102), the relatively-low bandwidth Y-axis actuator 104 may be mounted on the relatively-low bandwidth Z-axis actuator 106 (e.g., so as to be movable by the relatively-low bandwidth Z-axis actuator 106, relatively-low bandwidth X-axis actuator 102, or any combination thereof), the B-axis actuator 114 may be mounted on the relatively-low bandwidth Y-axis actuator 104 (e.g., so as to be movable by the relatively-low bandwidth Y-axis actuator 104, relatively-low bandwidth Z-axis actuator 106, relatively-low bandwidth X-axis actuator 102, or any combination thereof) and the C-axis actuator 116 may be mounted on the B-axis actuator 114 (e.g., so as to be movable by the B-axis actuator 114, relatively-low bandwidth Y-axis actuator 104, relatively-low bandwidth Z-axis actuator 106, relatively-low bandwidth X-axis actuator 102, or any combination thereof). FIG. 2A schematically illustrates the exemplary arrangement of actuators in a workpiece positioning assembly (e.g., workpiece positioning assembly 200), as discussed above. In other embodiments, however, one or more of the actuators within the workpiece positioning assembly 200 may be differently arranged in any other suitable or desirable manner.

It should also be recognized that one or more of the relatively-low bandwidth X-axis actuator 102, relatively-low bandwidth Y-axis actuator 104, relatively-low bandwidth Z-axis actuator 106, B-axis actuator 114 and C-axis actuator 116 may be omitted from the workpiece positioning assembly, as suitable or if otherwise desired. For example, the relatively-low bandwidth X-axis actuator 102 and the relatively-low bandwidth Z-axis actuator 106 may be omitted from the workpiece positioning assembly 200, and FIG. 2B schematically illustrates the exemplary arrangement of actuators in the resulting workpiece positioning assembly (i.e., as workpiece positioning assembly 201). In other embodiments, however, one or more of the actuators within the workpiece positioning assembly 201 may be differently arranged in any other suitable or desirable manner.

In view of the above, it should be recognized that each of the relatively-low bandwidth X-axis actuator 102, relatively-low bandwidth Y-axis actuator 104, relatively-low bandwidth Z-axis actuator 106, B-axis actuator 114 and C-axis actuator 116 may be provided as one or more stages (e.g., direct-drive stages, lead-screw stages, ball-screw stages, belt-driven stages, etc.), each driven by one or more hydraulic cylinders, one or more pneumatic cylinders, one or more servo motors, one or more voice-coil actuators, one or more piezoelectric actuators, one or more electrostrictive elements, or the like or any combination thereof. Moreover, any of the relatively-low bandwidth X-axis actuator 102, relatively-low bandwidth Y-axis actuator 104, relatively-low bandwidth Z-axis actuator 106, B-axis actuator 114 and C-axis actuator 116 may be configured to provide continuous or stepped (incremental) motion.

A workpiece fixture (not shown) may be mechanically coupled to the workpiece positioning assembly (e.g., at the relatively-low bandwidth C-axis actuator 116) to hold, retain, carry, etc., the workpiece in any suitable or desired manner. Accordingly, the workpiece can be coupled to the workpiece positioning assembly by way of the fixture. The workpiece fixture may be provided as one or more chucks or other clamps, clips, or other fastening devices (e.g., bolts, screws, pins, retaining rings, straps, ties, etc.), to which the workpiece can be clamped, fixed, held, secured or be otherwise supported.

### B. Embodiments Concerning the Tool Tip Positioning Assembly

In one embodiment, the relatively-high bandwidth X-axis actuator 108, relatively-high bandwidth Y-axis actuator 110 and the relatively-high bandwidth Z-axis actuator 112 may be incorporated within a type of positioning assembly referred to herein as a “tool tip positioning assembly.” The tool tip positioning assembly is configured to position or otherwise move a tool tip associated with the multi-axis machine tool along the X-axis, Y-axis, Z-axis, or any combination thereof, either simultaneously or non-simultaneously. It should be recognized, however, that one or more of the relatively-high bandwidth X-axis actuator 108, relatively-high bandwidth Y-axis actuator 110 and the relatively-high bandwidth Z-axis actuator 112 may be omitted from the tool tip positioning assembly, as suitable or if otherwise desired. For example, the relatively-high bandwidth Z-axis actuator 112 may be omitted from the tool tip positioning assembly. Generally, the tool tip positioning assembly does not include any rotary actuators. Nevertheless, it should be recognized that the tool tip positioning assembly can be configured to include one or more rotary actuators (e.g., one or more A-, B- or C-axis rotary actuators) if desired.

In addition to the aforementioned relatively-high bandwidth actuators included in the tool tip positioning assembly (i.e., the relatively-high bandwidth X-axis actuator 108, relatively-high bandwidth Y-axis actuator 110 and the relatively-high bandwidth Z-axis actuator 112), the tool tip positioning assembly may further include one or more of the relatively-low bandwidth actuators. For example, in one embodiment, the tool tip positioning assembly includes one or more relatively-low bandwidth actuators not incorporated within the workpiece positioning assembly. For example, in an embodiment in which the workpiece positioning assembly includes the relatively-low bandwidth Y-axis actuator 104, B-axis actuator 114 and C-axis actuator 116 (e.g., where the B-axis actuator 114 is mounted on the relatively-low bandwidth Y-axis actuator 104 so as to be movable by the relatively-low bandwidth Y-axis actuator 104 and the C-axis actuator 116 is mounted on the B-axis actuator 114 so as to be movable by the B-axis actuator 114, the relatively-low bandwidth Y-axis actuator 104, or any combination thereof), the tool tip positioning assembly can include the relatively-low bandwidth X-axis actuator 102 and the relatively-low bandwidth Z-axis actuator 106 (e.g., where the relatively-low bandwidth Z-axis actuator 106 is mounted on the relatively-low bandwidth X-axis actuator 102 so as to be movable by the relatively-low bandwidth X-axis actuator 102). In this embodiment, one or more of the relatively-high bandwidth X-axis actuator 108, the relatively-high bandwidth Y-axis actuator 110 and the relatively-high bandwidth Z-axis actuator 112 may be mounted to the relatively-low bandwidth Z-axis actuator 106, to the relatively-low bandwidth X-axis actuator 102, or to any other component (movable or stationary) of the multi-axis machine tool.

Generally, and depending upon the mechanism that is used to effect the processing of a workpiece (i.e., the “tool” to be used), the tool tip positioning assembly can be characterized as a “serial tool tip positioning assembly,” as a “parallel tool tip positioning assembly” or a “hybrid tool tip positioning assembly” (e.g., combining characteristics unique to the serial tool tip positioning assembly and the parallel tool tip positioning assembly).

### i. Embodiments Concerning the Serial Tool Tip Positioning Assembly

In one embodiment, a serial tool tip positioning assembly can be employed when the tool to be used is a mechanical structure (e.g., a router bit, a drill bit, a tool bit, a grinding bit, a blade, etc.). Within a serial tool tip positioning assembly, each of the relatively-high bandwidth X-axis actuator 108, relatively-high bandwidth Y-axis actuator 110 and relatively-high bandwidth Z-axis actuator 112 may include one or more components (e.g., stages, fixtures, chucks, rails, bearings, brackets, clamps, straps, bolts, screws, pins, retaining rings, ties, etc., not shown) to permit one or more of such actuators to be mounted or otherwise mechanically coupled to one another. In this case, the relatively-high bandwidth Y-axis actuator 110 may be mounted on the relatively-high bandwidth X-axis actuator 108 (e.g., so as to be movable by the relatively-high bandwidth X-axis actuator 108) and the relatively-high bandwidth Z-axis actuator 112 may be mounted on the relatively-high bandwidth Y-axis actuator 110 (e.g., so as to be movable by the relatively-high bandwidth Y-axis actuator 110, relatively-high bandwidth X-axis actuator 108, or any combination thereof). In other embodiments, however, one or more of the actuators within the serial tool tip positioning assembly may be different arranged in any other suitable or desirable manner. The serial tool tip positioning assembly is typically employed when the tool to be used includes a mechanical structure (e.g., a router bit, a drill bit, a tool bit, a grinding bit, a blade, etc.). The serial tool tip positioning assembly can also be employed when the tool to be used includes a stream or jet of matter (e.g., water, air, sand or other abrasive particles, paint, metallic powder, or the like or any combination thereof) ejected from, for example, a nozzle, head, etc.

In view of the above, it should be recognized that each of the relatively-high bandwidth X-axis actuator 108, relatively-high bandwidth Y-axis actuator 110 and relatively-high bandwidth Z-axis actuator 112 in the serial tool tip positioning assembly may be provided as one or more linear stages (e.g., direct-drive stages, lead-screw stages, ball-screw stages, belt-driven stages, etc.), each driven by one or more hydraulic cylinders, one or more pneumatic cylinders, one or more servo motors, one or more voice-coil actuators, one or more piezoelectric actuators, one or more electrostrictive elements, or the like or any combination thereof. Moreover, any of the relatively-high bandwidth X-axis actuator 108, relatively-high bandwidth Y-axis actuator 110 and relatively-high bandwidth Z-axis actuator 112 in the serial tool tip positioning assembly may be configured to provide continuous or stepped (incremental) motion.

A tool fixture (not shown) may be mechanically coupled to the serial tool tip positioning assembly (e.g., at the relatively-high bandwidth Z-axis actuator 112) to hold, retain, carry, etc., a mechanical structure (e.g., a router bit, a drill bit, a tool bit, a grinding bit, a blade, etc.) in any suitable or desired manner. Accordingly, the mechanical structure can be coupled to the serial tool tip positioning assembly by way of a tool fixture, which may be provided as one or more chucks or other clamps, clips, or other fastening devices (e.g., bolts, screws, pins, retaining rings, straps, ties, etc.). If the tool to be used includes a stream or jet of matter (e.g., water, air, sand or other abrasive particles, paint, metallic powder, or the like or any combination thereof, provided by a source of water, air, sand, particles, paint, powder, or the like or any combination thereof, as is known in the art), then the nozzle, head, etc., from which the stream or jet is ejected can be characterized as a “tool fixture.”

### ii. Embodiments Concerning the Parallel Tool Tip Positioning Assembly

In one embodiment, a parallel tool tip positioning assembly can be employed when the tool to be used is a beam of directed energy, etc. Within a parallel tool tip positioning assembly, the nature and configuration of one or more of the relatively-high bandwidth X-axis actuator 108, relatively-high bandwidth Y-axis actuator 110 and relatively-high bandwidth Z-axis actuator 112 will depend upon the tool to be used.

For example, if the tool to be used is a beam of electrons or ions (e.g., generated from an electron or ion source, not shown, as is known in the art), the relatively-high bandwidth X-axis actuator 108, the relatively-high bandwidth Y-axis actuator 110 and the relatively-high bandwidth Z-axis actuator 112 may be provided as one or more magnetic lenses, cylinder lenses, Einzel lenses, quadrupole lenses, multipole lenses, or the like or any combination thereof.

In another example, if the tool to be used is laser light (e.g., manifested as a series of pulses, as a continuous or quasi-continuous beam of laser light, or any combination thereof, generated from one or more laser sources as is known in the art), each of the relatively-high bandwidth X-axis actuator 108 and the relatively-high bandwidth Y-axis actuator 110 may be provided as a galvanometer-driven mirror system, a fast-steering mirror system (e.g., a mirror actuated by a voice-coil motor, a piezoelectric actuator, an electrostrictive actuator, a magnetostrictive actuator, etc.), microelectromechanical systems (MEMS) mirror system, an adaptive optical (AO) system, an electro-optic deflector (EOD) system, an acousto-optic deflector (AOD) system (e.g., arranged and configured to diffract laser light along an axis, such as the X- or Y-axis, in response to an applied RF signal), or the like or any combination thereof. If the tool is to be provided as a focused beam of laser light (in which case the “tool tip” is a region of the focused beam of laser light having a fluence sufficiently high to process the workpiece), then a relatively high-bandwidth Z-axis actuator 112 can be provided as one or more AOD systems (e.g., arranged and configured to diffract laser light along two axes, such as the X- and Y-axes, in response to one or more applied, chirped RF signals), a fixed focal-length lens that is disposed in a path along which the laser light propagates (i.e., a “propagation path”) and that is coupled to an actuator (e.g., a voice-coil) configured to move the lens along the propagation path, a variable-focal length lens (e.g., a zoom lens, or a so-called “liquid lens” incorporating technologies currently offered by COGNEX, VARIOPTIC, etc.) disposed in the propagation path, or the like or any combination thereof.

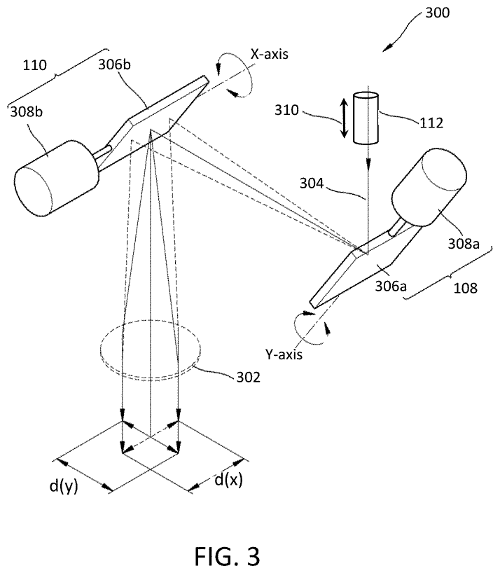

FIG. 3 schematically illustrates one embodiment of a parallel tool tip positioning assembly configured to position or otherwise move a tool tip associated with a focused beam of laser light. Referring to FIG. 3, the parallel tool tip positioning assembly 300 optionally includes a scan lens 302 (e.g., f-theta lens, a telecentric lens, an axicon lens, etc.) configured to focus a beam of laser light propagating along a propagation path 304, which has been deflected by a first galvanometer-driven mirror system (provided here as the relatively-high bandwidth X-axis actuator 108) and a second galvanometer-driven mirror system (provided here as the relatively-high bandwidth Y-axis actuator 110). As illustrated, the first galvanometer-driven mirror system includes a mirror 306a coupled to a motor 308a (e.g., via a shaft), which is configured to rotate the mirror 306a about the Y-axis (e.g., so as to permit deflection of the beam of laser light along the X-axis). Similarly, the second galvanometer-driven mirror system includes a mirror 306b coupled to a motor 308b (e.g., via a shaft), which is configured to rotate the mirror 306b about the X-axis (e.g., so as to permit deflection of the beam of laser light along the Y-axis). As a relatively-high bandwidth Z-axis actuator 112, the parallel tool tip positioning assembly 300 may also include a lens coupled to an actuator (e.g., a voice-coil, not shown), which is configured to move the lens along the propagation path 304 in the directions indicated by the double-arrows at 310.

In some cases, the functionality provided by two or more of the relatively-high bandwidth X-axis actuator 108, the relatively-high bandwidth Y-axis actuator 110 and the relatively-high bandwidth Z-axis actuator 112 can be provided by the same system. For example, systems such as a fast-steering mirror system, a MEMS mirror system, an AO system, etc., can be driven to deflect laser light along the X- and Y-axes. Systems such as a MEMS mirror system, an AO system, and a pair of AOD systems (e.g., one AOD system arranged and configured to diffract laser light along the X-axis and another AOD system arranged and configured to diffract laser light along the Y-axis), can be driven to deflect laser light along the X- and Y-axes and to change the size of a spot illuminated by the laser light at the tooling region (thus effectively changing the position of the beam waist of focused laser light delivered to the workpiece during processing along the Z-axis). Such systems can, therefore, be characterized as a relatively-high bandwidth X-axis actuator 108, a relatively-high bandwidth Y-axis actuator 110, a relatively-high bandwidth Z-axis actuator 112, or any combination thereof, depending upon the manner in which they are provided and driven.

### iii. Embodiments Concerning the Hybrid Tool Tip Positioning Assembly

In one embodiment, a hybrid tool tip positioning assembly can be employed when the tool to be used is a beam of directed energy, etc. For example, when provided as a system such as a galvanometer-driven mirror system, a fast-steering mirror system (e.g., a mirror actuated by a voice-coil motor, a piezoelectric actuator, an electrostrictive actuator, a magnetostrictive actuator, etc.), MEMS mirror system, an AO system, an EOD system, an AOD system, etc., the relatively-high bandwidth X-axis actuator 108 and/or the relatively-high bandwidth Y-axis actuator 110 may be mounted to or otherwise mechanically coupled to the relatively-high bandwidth Z-axis actuator 112 (e.g., so as to be movable by the relatively-high bandwidth Z-axis actuator 112). In this example, the relatively-high bandwidth Z-axis actuator 112 may be provided as one or more stages (e.g., direct-drive stages, lead-screw stages, ball-screw stages, belt-driven stages, etc.), each driven by one or more hydraulic cylinders, one or more pneumatic cylinders, one or more servo motors, one or more voice-coil actuators, one or more piezoelectric actuators, one or more electrostrictive elements, or the like or any combination thereof.

In another example, when provided as a system such as a galvanometer-driven mirror system, a fast-steering mirror system (e.g., a mirror actuated by a voice-coil motor, a piezoelectric actuator, an electrostrictive actuator, a magnetostrictive actuator, etc.), MEMS mirror system, an AO system, an EOD system, an AOD system, etc., the relatively-high bandwidth X-axis actuator 108 and/or the relatively-high bandwidth Y-axis actuator 110 may be mounted to or otherwise mechanically coupled to a relatively-low bandwidth Z-axis actuator 106 (e.g., so as to be movable by the relatively-low bandwidth Z-axis actuator 106). The hybrid tool tip positioning assembly may further include a relatively-high bandwidth Z-axis actuator 112 (e.g., provided as discussed herein with respect to the parallel tool tip positioning assembly), which may also be mounted to or otherwise mechanically coupled to the relatively-low bandwidth Z-axis actuator 106 as discussed in any of the embodiments provided herein (e.g., so as to be movable by the relatively-low bandwidth Z-axis actuator 106). Alternatively, the relatively-high bandwidth Z-axis actuator 112 may be mounted to or otherwise mechanically coupled to any other component (movable or stationary) of the multi-axis machine tool. In addition to the relatively-high bandwidth X-axis actuator 108, the relatively-high bandwidth Y-axis actuator 110, the relatively-high bandwidth Z-axis actuator 112 and the relatively-low bandwidth Z-axis actuator 106, the hybrid tool tip positioning assembly may further include the relatively-low bandwidth X-axis actuator 102. The relatively-low bandwidth Z-axis actuator 106 may, in turn, be mounted to or otherwise mechanically coupled to the relatively-low bandwidth X-axis actuator 102. In this example, each of the relatively-low bandwidth X-axis actuator 102 and the relatively-low bandwidth Z-axis actuator 106 may be provided as one or more stages (e.g., direct-drive stages, lead-screw stages, ball-screw stages, belt-driven stages, etc.), each driven by one or more hydraulic cylinders, one or more pneumatic cylinders, one or more servo motors, one or more voice-coil actuators, one or more piezoelectric actuators, one or more electrostrictive elements, or the like or any combination thereof.

In another example, when provided as a system such as a MEMS mirror system, an AO system, a pair of AOD systems, etc., the relatively-high bandwidth Z-axis actuator 112 may be mounted to or otherwise mechanically coupled to one of the relatively-high bandwidth X-axis actuator 108 and the relatively-high bandwidth Y-axis actuator 110 which, in turn, may be mounted to or otherwise mechanically coupled to the other of the relatively-high bandwidth X-axis actuator 108 and the relatively-high bandwidth Y-axis actuator 110. In this example, each of the relatively-high bandwidth X-axis actuator 108 and the relatively-high bandwidth Y-axis actuator 110 may be provided as one or more stages (e.g., direct-drive stages, lead-screw stages, ball-screw stages, belt-driven stages, etc.), each driven by one or more hydraulic cylinders, one or more pneumatic cylinders, one or more servo motors, one or more voice-coil actuators, one or more piezoelectric actuators, one or more electrostrictive elements, or the like or any combination thereof.

### C. Additional Comments Concerning the Workpiece and Tool Tip Positioning Assemblies

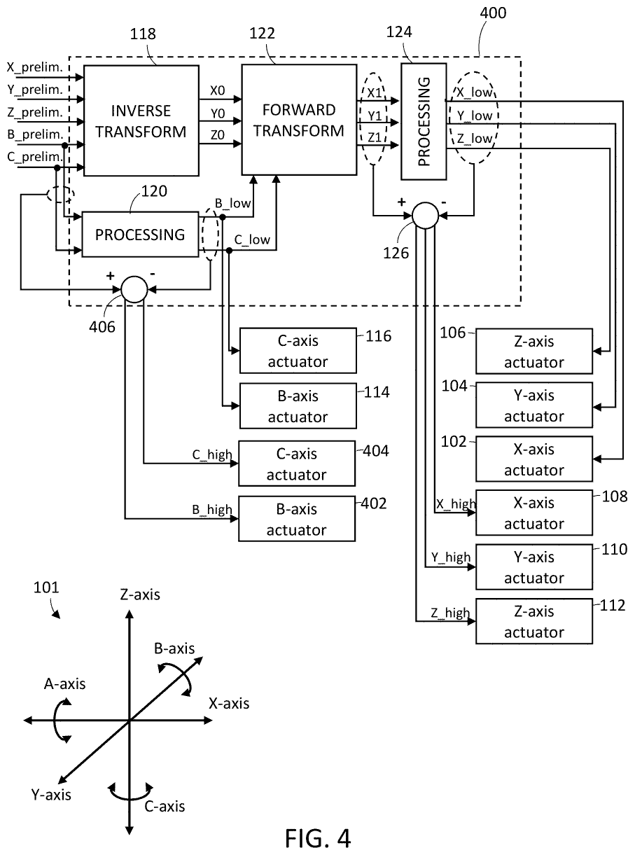

Notwithstanding the above, it should be recognized that any of the relatively-low bandwidth actuators described above as being incorporated within the workpiece positioning assembly (e.g., to position and/or move the workpiece) can, additionally or alternatively, be incorporated as part of the tool tip positioning assembly (e.g., to position and/or move the tool tip). Further, and notwithstanding the above, it should be recognized that the workpiece positioning assembly can, in some embodiments, be provided as any 5-axis workpiece positioning/moving assembly currently available in the industry, such as those found in the AGIECHARMILLES laser product line offered by GF MACHINING SOLUTIONS MANAGEMENT SA, the MICROLUTION ML-D offered by MICROLUTION, INC., the LASERTEC product line offered by DMG MORI AKIENGESELLSHAFT/DMG MORI COMPANY LIMITED. In one embodiment, the workpiece positioning assembly can be provided as described in FIGS. 4A-4C of aforementioned U.S. Pat. No. 8,392,002.

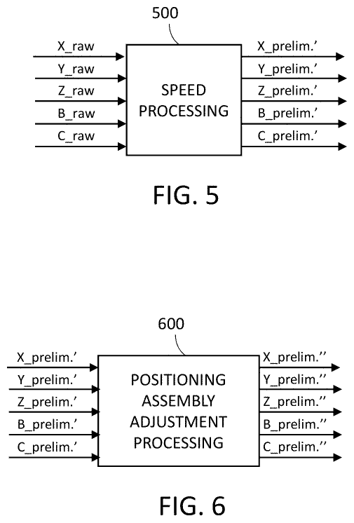

Likewise, and notwithstanding the above, it should be recognized that the tool tip positioning assembly can, in some embodiments, be provided as any laser scanning or focusing assembly currently available in the industry, such as those found in the 3-axis scanning systems offered by CAMBRIDGE TECHNOLOGY, the MINISCAN, SUPERSCAN, AXIALSCAN and FOCUSSHIFER product lines offered by RAYLASE, the MD-series 3-axis hybrid laser marker product line offered by KEYENCE CORP., the WOMBAT, ANTEATER, ELEPHANT, PRECISION ELEPHANT and PRECISION ELEPHANT 2 series of scan heads offered by ARGES GmbH, the LASERTEC product line offered by DMG MORI AKIENGESELLSHAFT/DMG MORI COMPANY LIMITED. Further, and notwithstanding the above, it should be recognized that the tool tip positioning assembly can, in some embodiments, be provided as described in any of U.S. Pat. No. 8,121,717 or International Patent Pub. No. WO 2014/009150 A1, each of which is incorporated herein by reference in its entirety, or as described in FIGS. 5A-5C of aforementioned U.S. Pat. No. 8,392,002.

Having exemplarily described certain components of one embodiment of a multi-axis machine tool above, an algorithm for processing and generating actuator commands to control the multi-axis machine tool, as implemented by the control system 100, now be discussed in greater detail with reference to FIG. 1.

### D. Embodiments Concerning Processing of Actuator Commands

Referring to FIG. 1, the control system 100 receives preliminary actuator commands (e.g., obtained or otherwise derived from a computer file or a computer program as discussed herein). As shown, the preliminary actuator commands include the following preliminary linear actuator commands: preliminary X-axis actuator command (i.e., X_prelim.), preliminary Y-axis actuator command (i.e., Y_prelim.), and preliminary Z-axis actuator command (i.e., Z_prelim.); and preliminary rotary actuator commands: preliminary B-axis actuator command (i.e., B_prelim.) and preliminary C-axis actuator command (i.e., C_prelim.). In one embodiment, at least one of the preliminary actuator commands will have non-negligible frequency content that exceeds the threshold frequency of a corresponding relatively-low bandwidth actuator. For example, the preliminary X-axis actuator command (i.e., X_prelim.) may have non-negligible frequency content that exceeds the threshold frequency of a corresponding relatively-low bandwidth X-axis actuator 102, the preliminary Y-axis actuator command (i.e., Y_prelim.) may have non-negligible frequency content that exceeds the threshold frequency of a corresponding relatively-low bandwidth Y-axis actuator 104, the preliminary Z-axis actuator command (i.e., Z_prelim.) may have non-negligible frequency content that exceeds the threshold frequency of a corresponding relatively-low bandwidth Z-axis actuator 106, the preliminary B-axis actuator command (i.e., B_prelim.) may have non-negligible frequency content that exceeds the threshold frequency of a corresponding relatively-low bandwidth B-axis actuator 114, the preliminary C-axis actuator command (i.e., C_prelim.) may have non-negligible frequency content that exceeds the threshold frequency of a corresponding relatively-low bandwidth C-axis actuator 116, or any combination thereof. It should be recognized, however, that any or all of the aforementioned preliminary actuator commands may have non-negligible frequency content that is at or below the threshold frequency of a corresponding relatively-low bandwidth actuator.

The preliminary actuator commands are processed to generate a first set of intermediate linear actuator commands. For example, an inverse kinematic transform 118 is applied to the preliminary X-axis actuator command (i.e., X_prelim.), preliminary Y-axis actuator command (i.e., Y_prelim.), preliminary Z-axis actuator command (i.e., Z_prelim.), preliminary B-axis actuator command (i.e., B_prelim.) and preliminary C-axis actuator command (i.e., C_prelim.) to generate the first set of intermediate linear actuator commands. The first set of intermediate linear actuator commands includes a first intermediate X-axis actuator command (i.e., X0), a first intermediate Y-axis actuator command (i.e., Y0) and a first intermediate Z-axis actuator command (i.e., Z0). The inverse kinematic transform 118 can be applied according to the following equation:

$$[ \begin{matrix}X 0 \\ Y 0 \\ Z 0\end{matrix} ] = [ \begin{matrix}cos ( C\_prelim . ) & sin ( C\_prelim . ) & 0 \\ - sin ( C\_prelim . ) & cos ( C\_prelim . ) & 0 \\ 0 & 0 & 1\end{matrix} ] \cdot [ \begin{matrix}cos ( B\_prelim . ) & 0 & - sin ( B\_prelim . ) \\ 0 & 1 & 0 \\ sin ( B\_prelim . ) & 0 & cos ( B\_prelim . )\end{matrix} ] \cdot [ \begin{matrix}\begin{matrix}X\_prelim . \\ Y\_prelim .\end{matrix} \\ Z\_prelim .\end{matrix} ]$$

As shown in the equation above, the inverse kinematic transform computes the first set of intermediate linear actuator commands at a fixed reference rotary position along the B- and C-axes. In the example given above, the fixed reference rotary position is 0 degrees for each of the B- and C-axes, but may be any other suitable or desired angle.

The preliminary rotary actuator commands (e.g., preliminary B-axis actuator command, B_prelim., and preliminary C-axis actuator command, C_prelim.) are subjected to a processing stage 120 to generate one or more processed rotary actuator commands. In the illustrated embodiment, Blow signifies a processed B-axis actuator command and C_low signifies a processed C-axis actuator command, both of which are generated at processing stage 120. At processing stage 120, a preliminary rotary actuator command can be subjected to one or more processes that, for example, includes applying one or more suitable filters to the preliminary rotary actuator command, modifying the preliminary rotary actuator command according to one or more suitable algorithms, decimating the preliminary rotary actuator command, applying one or more low-order interpolation to the preliminary rotary actuator command, or the like or any combination thereof. Examples of suitable filters include digital filters, low pass filters, Butterworth filters, or the like or any combination thereof. Examples of suitable algorithms include an auto-regressive moving-average algorithm, or the like. A processed rotary actuator command corresponds to a preliminary rotary actuator command, but does not have any (or has only negligible amounts of) frequency content that exceeds the threshold frequency of a corresponding rotary actuator. Thus, the processed B-axis actuator command (i.e., B_low) does not have any (or has only negligible amounts of) frequency content that exceeds the threshold frequency of the relatively-low bandwidth B-axis actuator 114, the processed C-axis actuator command (i.e., C_low) does not have any (or has only negligible amounts of) frequency content that exceeds the threshold frequency of the relatively-low bandwidth C-axis actuator 116, etc. As used herein, each of the above-noted processed rotary actuator commands is also referred to herein as “low-frequency content rotary actuator commands” or, more generally, “low-frequency content actuator commands.”

The first set of intermediate linear actuator commands and the processed rotary commands are processed to generate a second set of intermediate linear actuator commands. For example, a forward kinematic transform 122 is applied to the first intermediate X-axis actuator command (i.e., X0), first intermediate Y-axis actuator command (i.e., Y0), first intermediate Z-axis actuator command (i.e., Z0), the processed B-axis actuator command (i.e., B_low) and the processed C-axis actuator command (i.e., C_low) to generate the second set of intermediate linear actuator commands. The second set of intermediate linear actuator commands includes a second intermediate X-axis actuator command (i.e., X1), a second intermediate Y-axis actuator command (i.e., Y1) and a second intermediate Z-axis actuator command (i.e., Z1). The forward kinematic transform can be applied according to the following equation:

$$[ \begin{matrix}X 1 \\ Y 1 \\ Z 1\end{matrix} ] = [ \begin{matrix}cos ( B\_low ) & 0 & sin ( B\_low ) \\ 0 & 1 & 0 \\ - sin ( B\_low ) & 0 & cos ( B\_low )\end{matrix} ] \cdot [ \begin{matrix}cos ( C\_low ) & - sin ( C\_low ) & 0 \\ sin ( C\_low ) & cos ( C\_low ) & 0 \\ 0 & 0 & 1\end{matrix} ] \cdot [ \begin{matrix}X 0 \\ Y 0 \\ Z 0\end{matrix} ]$$

The second set of intermediate linear actuator commands (e.g., second intermediate X-axis actuator command, X1, second intermediate Y-axis actuator command, Y1, and second intermediate Z-axis actuator command, Z1) are subjected to a processing stage 124 to generate a first set of processed linear actuator commands. The first set of processed linear actuator commands can include a low-frequency content X-axis actuator command (i.e., X_low), a low-frequency content Y-axis actuator command (i.e., Y_low) and a low-frequency content Z-axis actuator command (i.e., Z_low). At processing stage 124, a second intermediate linear actuator command can be subjected to one or more processes that, for example, includes applying one or more suitable filters to the second intermediate linear actuator command, modifying the second intermediate linear actuator command according to one or more suitable algorithms, decimating the second intermediate linear actuator command, applying one or more low-order interpolation to the second intermediate linear actuator command, or the like or any combination thereof. Examples of suitable filters include digital filters, low pass filters, Butterworth filters, or the like or any combination thereof. Examples of suitable algorithms include an auto-regressive moving-average algorithm, or the like. A processed linear actuator command corresponds to a preliminary linear actuator command, but does not have any (or has only negligible amounts of) frequency content that exceeds the threshold frequency of a corresponding linear actuator. Thus, the low-frequency content X-axis actuator command (i.e., X_low) does not have any (or has only negligible amounts of) frequency content that exceeds the threshold frequency of the relatively-low bandwidth X-axis actuator 102, the low-frequency content Y-axis actuator command (i.e., Y_low) does not have any (or has only negligible amounts of) frequency content that exceeds the threshold frequency of the relatively-low bandwidth Y-axis actuator 104 and the low-frequency content Z-axis actuator command (i.e., Z_low) does not have any (or has only negligible amounts of) frequency content that exceeds the threshold frequency of the relatively-low bandwidth Z-axis actuator 106.

The low-frequency content linear actuator commands (e.g., X_low, Y_low and Z_low) are subtracted from corresponding actuator commands in the second set of intermediate linear actuator commands to generate a second set of processed linear actuator commands. The second set of processed linear actuator commands can include a high-frequency content X-axis actuator command (i.e., X_high), a high-frequency content Y-axis actuator command (i.e., Y_high) and a high-frequency content Z-axis actuator command (i.e., Z_high). For example, the low-frequency content X-axis actuator command (i.e., X_low) can be subtracted from the second intermediate X-axis actuator command (i.e., X1) to yield the high-frequency content X-axis actuator command (i.e., X_high), the low-frequency content Y-axis actuator command (i.e., Y_low) can be subtracted from the second intermediate Y-axis actuator command (i.e., Y1) to yield the high-frequency content Y-axis actuator command (i.e., Y_high) and the low-frequency content Z-axis actuator command (i.e., Z_low) can be subtracted from the second intermediate Z-axis actuator command (i.e., Z1) to yield the high-frequency content Z-axis actuator command (i.e., Z_high). The subtraction discussed above may be implemented at a summer 126, which can be implemented in any suitable or desired manner known in the art. Typically, the high-frequency content X-axis actuator command (i.e., X_high) has a frequency content that exceeds the threshold frequency of the relatively-low bandwidth X-axis actuator 102, but that is at or below the threshold frequency of the relatively-high bandwidth X-axis actuator 108. Likewise, the high-frequency content Y-axis actuator command (i.e., Y_high) has a frequency content that exceeds the threshold frequency of the relatively-low bandwidth Y-axis actuator 104, but that is at or below the threshold frequency of the relatively-high bandwidth Y-axis actuator 110; and the high-frequency content Z-axis actuator command (i.e., Z_high) has a frequency content that exceeds the threshold frequency of the relatively-low bandwidth Z-axis actuator 106, but that is at or below the threshold frequency of the relatively-high bandwidth Z-axis actuator 112.

Ultimately, and as shown, the low-frequency content X-axis actuator command (i.e., X_low), the low-frequency content Y-axis actuator command (i.e., Y_low), the low-frequency content Z-axis actuator command (i.e., Z_low), the high-frequency content X-axis actuator command (i.e., X_high), the high-frequency content Y-axis actuator command (i.e., Y_high), the high-frequency content Z-axis actuator command (i.e., Z_high), the low-frequency content B-axis actuator command (i.e., B_low) and the low-frequency content C-axis actuator command (i.e., C_low) are output, respectively, to the relatively-low bandwidth X-axis actuator 102, relatively-low bandwidth Y-axis actuator 104, relatively-low bandwidth Z-axis actuator 106, relatively-high bandwidth X-axis actuator 108, relatively-high bandwidth Y-axis actuator 110, relatively-high bandwidth Z-axis actuator 112, B-axis actuator 114 and C-axis actuator 116.

Although not illustrated, the control system 100 may include one or more delay buffers to compensate for any processing or transport delays caused by the generation of the low-frequency content X-axis actuator command (i.e., X_low), the low-frequency content Y-axis actuator command (i.e., Y_low), the low-frequency content Z-axis actuator command (i.e., Z_low), the high-frequency content X-axis actuator command (i.e., X_high), the high-frequency content Y-axis actuator command (i.e., Y_high), the high-frequency content Z-axis actuator command (i.e., Z_high), the low-frequency content B-axis actuator command (i.e., B_low) and the low-frequency content C-axis actuator command (i.e., C_low) and/or the output of any of these actuator commands to their respective actuator, so that the actuator commands can be output in a synchronized or otherwise coordinated manner. Upon outputting the actuator commands in a synchronized or otherwise coordinated manner, the actuators essentially react or respond in a similarly synchronized or otherwise coordinated manner to impart relative movement between the tool tip and the workpiece in manner that moves the tooling region along the tool path.

Generally, the control system 100 may be implemented by one or more controllers that are communicatively coupled (e.g., over one or more wired or wireless communications links, such as USB, RS-232, Ethernet, Firewire, Wi-Fi, RFID, NFC, Bluetooth, Li-Fi, SERCOS, MARCO, EtherCAT, or the like or any combination thereof) to one or more components of the multi-axis machine tool (e.g., one or more of the aforementioned actuators, one or more components controlling or otherwise affecting an operation of the tool, or the like or any combination thereof). Generally, a controller can be characterized as including one or more processors configured to process and generate the aforementioned actuator commands upon executing instructions. A processor can be provided as a programmable processor (e.g., including one or more general purpose computer processors, microprocessors, digital signal processors, or the like or any combination thereof) configured to execute the instructions. Instructions executable by the processor(s) may be implemented software, firmware, etc., or in any suitable form of circuitry including programmable logic devices (PLDs), field-programmable gate arrays (FPGAs), field-programmable object arrays (FPOAs), application-specific integrated circuits (ASICs)— including digital, analog and mixed analog/digital circuitry—or the like, or any combination thereof. Execution of instructions can be performed on one processor, distributed among processors, made parallel across processors within a device or across a network of devices, or the like or any combination thereof. In one embodiment, a controller includes tangible media such as computer memory, which is accessible (e.g., via one or more wired or wireless communications links) by the processor. As used herein, “computer memory” includes magnetic media (e.g., magnetic tape, hard disk drive, etc.), optical discs, volatile or non-volatile semiconductor memory (e.g., RAM, ROM, NAND-type flash memory, NOR-type flash memory, SONOS memory, etc.), etc., and may be accessed locally, remotely (e.g., across a network), or a combination thereof. Generally, the instructions may be stored as computer software (e.g., executable code, files, instructions, etc., library files, etc.), which can be readily authored by artisans, from the descriptions provided herein, e.g., written in C, C++, Visual Basic, Java, Python, Tel, Perl, Scheme, Ruby, etc. Computer software is commonly stored in one or more data structures conveyed by computer memory.

Although not shown, one or more drivers (e.g., RF drivers, servo drivers, line drivers, power sources, etc.) are communicatively coupled to an input of one or more of the aforementioned actuators, one or more components controlling or otherwise affecting an operation of the tool, or the like or any combination thereof. Each driver typically includes an input to which the controller is communicatively coupled. The controller is thus operative to generate one or more control signals (e.g., actuator commands, tool control commands, etc.) which can be transmitted to the input(s) of one or more drivers associated with one or more components of the multi-axis machine tool. Upon receiving a control signal, a driver typically causes an electric current to be supplied to the component to which it is coupled (e.g., actuator, tool, etc.) in order to operate the component and produce an effect that corresponds to the command signal. Thus, components such as the aforementioned actuators, the tool, etc., are responsive to command signals (e.g., actuator commands, tool control commands, etc.) generated and output by the controller.

In view of the above, it will be appreciated that the control system 100 can be used to continuously provide synchronized and coordinated operation of the relatively-low bandwidth actuators (e.g., having a relatively large range of motion) and relatively-high bandwidth actuators of the multi-axis machine tool (e.g., having a relatively small range of motion) to position or otherwise move a tooling region relative to the workpiece (e.g., in a manner that accurately and reliably corresponds to a desired trajectory). While the control system 100 can accurately position the tooling region relative to the workpiece (e.g., according to the desired trajectory), it is possible that the tooling angle ultimately manifested at any point during workpiece processing can deviate from a reference tooling angle. Generally, the reference tooling angle is typically 0 degrees, as measured from a line normal to a portion of the surface of the workpiece that is intersected by the tooling axis, but can be any other angle (e.g., as specified or otherwise required, either explicitly or implicitly, by the trajectory). Generally, the deviation in tooling angle arises if a high-frequency content linear actuator command has frequency content exceeding the threshold frequency of a rotary actuator that is not part of a set of redundant rotary actuators. Depending upon the speed with which the tooling region is (or is to be) moved relative to the workpiece, the deviation in tooling angle can be greater than 15 degrees, and even greater than or equal to 50 degrees. Such tooling angle deviations can, however, be pre-calculated (e.g., based on the characteristics of the actuators in the multi-axis machine tool, based on the desired trajectory, etc.) and compensated for (either completely or partially) during workpiece processing (e.g., by adjusting the speed with which the tooling region is moved relative to the workpiece, by adjusting the processing at one or more of processing stages 120 and 124, or the like or any combination thereof). As a result of the compensation and optimization, the magnitude of the deviation of the tooling angle actually obtained from the reference tooling angle (measured in degrees), can be reduced to under 10 degrees (e.g., less than or equal to 8 degrees, 6 degrees, 5 degrees, 4 degrees, 2 degrees, 1 degree, 0.5 degrees, etc., or between any of these values).

### III. Controlling a Multi-Axis Machine Tool Having Axially-Complementary Actuators and Redundant Rotary Actuators

FIG. 4 is a block diagram schematically illustrating a control system 400 for controlling a multi-axis machine tool which, according to one embodiment, includes actuators such as those exemplarily discussed above with respect to FIGS. 1 to 3. In the current embodiment, however, the multi-axis machine tool may additionally include a B-axis actuator 402, a C-axis actuator 404, or the B-axis actuator 402 and the C-axis actuator 404. The threshold frequency of the B-axis actuator 402 is higher than the threshold frequency of the B-axis actuator 114. Accordingly, the B-axis actuator 114 can also be referred to herein as a “relatively-low bandwidth B-axis actuator” and the B-axis actuator 402 can also be referred to herein as a “relatively-high bandwidth B-axis actuator.” Likewise, the threshold frequency of the C-axis actuator 404 is higher than the threshold frequency of the C-axis actuator 116. Accordingly, the C-axis actuator 116 can also be referred to herein as a “relatively-low bandwidth C-axis actuator” and the C-axis actuator 404 can also be referred to herein as a “relatively-high bandwidth B-axis actuator.”

The relatively-low and relatively-high bandwidth B-axis actuators 114 and 402, respectively, constitute a set of redundant actuators (i.e., a set of redundant B-axis actuators). Likewise, a set of redundant actuators is constituted by each pair of the relatively-low and relatively-high bandwidth C-axis actuators 116 and 404, respectively (i.e., a set of redundant C-axis actuators). Although the illustrated embodiment describes a multi-axis machine tool having a set of redundant actuators constituted by only two rotary actuators, it will be appreciated that the multi-axis machine tool may be further equipped with one or more additional rotary actuators arranged or configured to impart movement along any of the B- or C-axes, so that any set of redundant actuators may include three or more rotary actuators.

In one embodiment, the relatively-high bandwidth B-axis actuator 402, considered with one or more actuators within the set of redundant X-axis actuators and/or one or more within the set of redundant Z-axis actuators, constitutes a set of axially-complementary actuators. In another embodiment, the relatively-high bandwidth C-axis actuator 404, considered with one or more actuators within the set of redundant X-axis actuators and/or one or more within the set of redundant Y-axis actuators, constitutes a set of axially-complementary actuators. In yet another embodiment, the relatively-high bandwidth B-axis and C-axis actuators 402 and 404, respectively, considered with one or more actuators within the set of redundant X-axis actuators, one or more actuators within the set of redundant Y-axis actuators and/or one or more within the set of redundant Z-axis actuators, constitutes a set of axially-complementary actuators.

### A. Embodiments Concerning the Tool Tip Positioning Assembly

In one embodiment, one or both of the relatively-high bandwidth B-axis actuator 402 and the relatively-high bandwidth C-axis actuator 404 may be incorporated within a tool tip positioning assembly as exemplarily described above, so that the resulting tool tip positioning assembly can be configured to position or otherwise move a tool tip associated with the multi-axis machine tool along B-axis and/or the C-axis in addition to the X-axis, Y-axis, Z-axis, or any combination thereof, either simultaneously or non-simultaneously. It should be recognized, however, that one or more of the relatively-high bandwidth X-axis actuator 108, relatively-high bandwidth Y-axis actuator 110, relatively-high bandwidth Z-axis actuator 112, relatively-high bandwidth B-axis actuator 402 and the relatively-high bandwidth C-axis actuator 404 may be omitted from the tool tip positioning assembly, as suitable or if otherwise desired. As mentioned above, a tool tip positioning assembly including one or both of the relatively-high bandwidth B-axis actuator 402 and the relatively-high bandwidth C-axis actuator 404 can be characterized as a “serial tool tip positioning assembly,” as a “parallel tool tip positioning assembly” or a “hybrid tool tip positioning assembly” (e.g., combining characteristics unique to the serial tool tip positioning assembly and the parallel tool tip positioning assembly).

### i. Embodiments Concerning the Serial Tool Tip Positioning Assembly

Within a serial tool tip positioning assembly (e.g., as described above), any of the relatively-high bandwidth B-axis actuator 402 and the relatively-high bandwidth C-axis actuator 404 may include one or more components (e.g., stages, fixtures, chucks, rails, bearings, brackets, clamps, straps, bolts, screws, pins, retaining rings, ties, etc., not shown) to permit the relatively-high bandwidth B-axis actuator 402 and the relatively-high bandwidth C-axis actuator 404 to be mounted or otherwise mechanically coupled to one another or to any of the aforementioned actuators included within the serial tool tip.

Each of the relatively-high bandwidth B-axis actuator 402 and relatively-high bandwidth C-axis actuator 404 in the serial tool tip positioning assembly may be provided as one or more rotary stages (e.g., direct-drive stages, lead-screw stages, ball-screw stages, belt-driven stages, etc.), each driven by one or more hydraulic cylinders, one or more pneumatic cylinders, one or more servo motors, one or more voice-coil actuators, one or more piezoelectric actuators, one or more electrostrictive elements, or the like or any combination thereof. Moreover, any of the relatively-high bandwidth B-axis actuator 402 and relatively-high bandwidth C-axis actuator 404 in the serial tool tip positioning assembly may be configured to provide continuous or stepped (incremental) motion.

A tool fixture (not shown) may be mechanically coupled to the serial tool tip positioning assembly at the relatively-high bandwidth Z-axis actuator 112 (as discussed above), at the relatively-high bandwidth B-axis actuator 402 or at the relatively-high bandwidth C-axis actuator 404 to hold, retain, carry, etc., a mechanical structure (e.g., a router bit, a drill bit, a tool bit, a grinding bit, a blade, etc.), or other structure from which a stream or jet of matter is ejected (e.g., a nozzle, head, etc.), in any suitable or desired manner.

### ii. Embodiments Concerning the Parallel Tool Tip Positioning Assembly

In one embodiment, the parallel tool tip positioning assembly includes a relatively-high bandwidth C-axis actuator 404, in addition to one or more of the relatively-high bandwidth X-axis actuator 108, the relatively-high bandwidth Y-axis actuator 110, and the relatively-high bandwidth Z-axis actuator 112, as exemplarily described above. In this case, the configuration of the relatively-high bandwidth C-axis actuator 404 will depend upon the tool to be used. Example embodiments discussed below relate to instances where the tool to be used includes laser light (e.g., manifested as a series of pulses, as a continuous or quasi-continuous beam of laser light, or any combination thereof, generated from one or more laser sources as is known in the art).

When the tool to be used is laser light, the laser light can be directed (e.g., along the aforementioned propagation path) to illuminate a portion of the workpiece at or near the tooling region. When viewed on the surface of the workpiece, or when otherwise viewed in a plane that is orthogonal to a portion of the propagation path intersecting the workpiece at the tooling region, the spatial intensity distribution of laser light at the illuminated portion (also referred to as a “spot”) can be characterized as having a circular shape or a non-circular shape. Examples of non-circular shapes include elliptical shapes, triangular shapes, square shapes, rectangular shapes, irregular shapes, etc. Circular or non-circular spot shapes can be created using one or more beam-cropping apertures, diffractive optical elements, AOD systems, prisms, lenses, etc. (which may be included as part of the multi-axis machine tool and disposed within the propagation path), in any suitable manner known in the art, or can be created as result of the beam of laser light illuminating a surface of the workpiece at the tooling region that is either non-planar or is not orthogonal to the portion of the propagation path intersecting the workpiece at the tooling region, or any combination thereof.

In view of the above, the relatively-high bandwidth C-axis actuator 404 can be disposed in the propagation path at any suitable or desired location that is optically “upstream” or optically “downstream” of any of the relatively-high bandwidth X-axis actuator 108 or the relatively-high bandwidth Y-axis actuator 110 in the parallel tool tip positioning assembly (e.g., the parallel tool tip positioning assembly 300). In one embodiment, the relatively-high bandwidth C-axis actuator 404 can be provided as a microelectromechanical systems (MEMS) mirror system, an adaptive optical (AO) system, or any combination thereof, and be configured to change the shape of the spatial intensity distribution relative to the propagation path in a manner that effectively changes the orientation of the spatial intensity distribution of the incident beam of laser light. In another embodiment, the relatively-high bandwidth C-axis actuator 404 can be provided as one or more prisms, which may be rotated (e.g., about an axis along which the propagation path extends) or otherwise moved by an actuator to change the orientation of the spatial energy distribution relative to the propagation path. In one embodiment, the relatively-high bandwidth C-axis actuator 404 can be provided as described in U.S. Pat. No. 6,362,454, which is incorporated herein by reference. In yet another embodiment, the relatively-high bandwidth C-axis actuator 404 can be provided as one or more AOD systems (e.g., arranged and configured to diffract laser light along two axes, such as the X- and Y-axes, in response to one or more applied, chirped RF signals).

In some cases, the functionality provided by the relatively-high bandwidth C-axis actuator 404 and one or more of the relatively-high bandwidth X-axis actuator 108, the relatively-high bandwidth Y-axis actuator 110 and the relatively-high bandwidth Z-axis actuator 112 can be provided by the same system. For example, systems such as a MEMS mirror system, an AO system, and a pair of AOD systems (e.g., one AOD system arranged and configured to diffract laser light along the X-axis and another AOD system arranged and configured to diffract laser light along the Y-axis), can be driven to deflect laser light along the X- and Y-axes, to change the size of a spot illuminated by the laser light at the tooling region (thus effectively changing the position of the beam waist of focused laser light delivered to the workpiece during processing along the Z-axis), and to change the orientation of the spatial energy distribution of a beam of laser light relative to the propagation path. Such systems can, therefore, be characterized as a relatively-high bandwidth X-axis actuator 108, a relatively-high bandwidth Y-axis actuator 110, a relatively-high bandwidth Z-axis actuator 112, a relatively-high bandwidth C-axis actuator 404, or any combination thereof, depending upon the manner in which they are provided and driven.

### iii. Embodiments Concerning the Hybrid Tool Tip Positioning Assembly

In one embodiment, a hybrid tool tip positioning assembly includes a relatively-high bandwidth B-axis actuator 402, in addition to one or more of the relatively-high bandwidth X-axis actuator 108, the relatively-high bandwidth Y-axis actuator 110, the relatively-high bandwidth Z-axis actuator 112, and the relatively-high bandwidth C-axis actuator 404 as exemplarily described above in connection with the serial tool tip positioning assembly. In this case, the relatively-high bandwidth B-axis actuator 402 is attached to and movable by one or more of the aforementioned actuators so as to be movable along the X-axis, Y-axis, Z-axis, C-axis or any combination thereof, either simultaneously or non-simultaneously. It will be appreciated that the configuration of the relatively-high bandwidth B-axis actuator 402 will depend upon the tool to be used. Example embodiments discussed below relate to instances where the tool to be used includes laser light (e.g., manifested as a series of pulses, as a continuous or quasi-continuous beam of laser light, or any combination thereof, generated from one or more laser sources as is known in the art). When the tool to be used is laser light, the laser light can be directed (e.g., along the aforementioned propagation path) to illuminate a portion of the workpiece at or near the tooling region.

### B. Additional Comments Concerning the Tool Tip Positioning Assembly

Notwithstanding the above, it should be recognized that any of the relatively-low bandwidth actuators described above as being incorporated within the workpiece positioning assembly (e.g., to position and/or move the workpiece) can, additionally or alternatively, be incorporated as part of a tool tip positioning assembly (e.g., to position and/or move the tool tip) that includes the relatively-high bandwidth B-axis actuator 402 or the relatively-high bandwidth C-axis actuator 404. Further, and notwithstanding the above, it should be recognized that the tool tip positioning assembly can, in some embodiments, be provided as any laser scanning or focusing assembly currently available in the industry, such as those found in the PRECISION ELEPHANT and PRECISION ELEPHANT 2 series of scan heads offered by ARGES GmbH. Further, and notwithstanding the above, it should be recognized that the tool tip positioning assembly can, in some embodiments, be provided as described in International Patent Pub. No. WO 2014/009150 A1, which is incorporated herein by reference in its entirety.

### C. Embodiments Concerning Processing of Actuator Commands

Generally, the control system 400 may be implemented by one or more controllers as exemplarily described with respect to the control system 100, and operation of the control system 400 is the same as the operation of the control system 100 discussed above with respect to FIG. 1 with the exception of some additional processes and operations introduced to account for the presence of the relatively-high bandwidth B-axis actuator 402, the relatively-high bandwidth C-axis actuator 404, or a combination thereof. These additional processes and operations will now be described below.

The low-frequency content rotary actuator commands (e.g., B_low and C_low) are subtracted corresponding actuator commands in the preliminary rotary actuator commands (e.g., preliminary B-axis actuator command, B_prelim., and preliminary C-axis actuator command, C_prelim.) to generate one or more further-processed rotary actuator commands. For example, the low-frequency content B-axis actuator command (i.e., B_low) can be subtracted from the preliminary B-axis actuator command (i.e., B_prelim.) to yield, as a further-processed rotary actuator command, a high-frequency content B-axis actuator command (i.e., B_high). Similarly, the low-frequency content C-axis actuator command (i.e., C_low) can be subtracted from the preliminary C-axis actuator command (i.e., C_prelim.) to yield, as a further-processed rotary actuator command, a high-frequency content C-axis actuator command (i.e., C_high). The subtraction discussed above may be implemented at a summer 406, which can be implemented in any suitable or desired manner known in the art. Typically, the high-frequency content B-axis actuator command (i.e., B_high) has a frequency content that exceeds the threshold frequency of the relatively-low bandwidth B-axis actuator 114, but that is at or below the threshold frequency of the relatively-high bandwidth B-axis actuator 402. Likewise, the high-frequency content C-axis actuator command (i.e., C_high) has a frequency content that exceeds the threshold frequency of the relatively-low bandwidth C-axis actuator 116, but that is at or below the threshold frequency of the relatively-high bandwidth C-axis actuator 404.

Ultimately, and as shown, the high-frequency content B-axis actuator command (i.e., B_high), the high-frequency content C-axis actuator command (i.e., C_high), or any combination thereof, are output to respective one of the relatively-high bandwidth B-axis actuator 402 and the relatively-high bandwidth C-axis actuator 404. Although not illustrated, the control system 400 may include one or more delay buffers to compensate for any processing or transport delays caused by the generation of the high-frequency content B-axis actuator command (i.e., B_high), the high-frequency content C-axis actuator command (i.e., C_high) and/or the output of any of these actuator commands to their respective actuator, so that the illustrated actuator commands can be output in a synchronized or otherwise coordinated manner. Upon outputting the actuator commands in a synchronized or otherwise coordinated manner, the actuators essentially react or respond in a similarly synchronized or otherwise coordinated manner to impart relative movement between the tool tip and the workpiece in manner that moves the tooling region along the tool path.

### IV. Additional Considerations Concerning Feature Quality

When the workpiece is processed using any of the aforementioned contactless-type tools, it is often desirable to direct the energy or stream or jet of matter such that the directed energy or matter is applied evenly (or at least somewhat or substantially evenly) to the workpiece. This helps to ensure that features formed within or on the workpiece have reproducible and/or uniform characteristics (e.g., in terms of width, depth, color, chemical composition, crystal structure, electronic structure, microstructure, nanostructure, density, viscosity, index of refraction, magnetic permeability, relative permittivity, exterior or interior visual appearance, etc.).

In some embodiments, the aforementioned goal can be achieved by ensuring that the instantaneous power of the directed energy (e.g., at the tooling region), that the pressure or velocity of a stream or jet of matter (e.g., at the tooling region), that the size of the tooling region, that the speed with which the tooling region moves along the tool path (also referred to herein as “tool speed”), or the like or any combination thereof, are all within acceptable limits, which may be predetermined based upon computer modeling, experimentation, or the like or any combination thereof. As used herein, parameters such as the instantaneous power of the directed energy or the pressure or velocity in a stream or jet of matter are also generically and collectively referred to as “tool power.”

In one embodiment, the aforementioned goal can be achieved by implementing a “constant ratio” technique, which involves varying the tool power when tool speed changes (or when tool speed changes by a predetermined amount) such that the ratio of the tool power to tool speed remains constant (or at least substantially constant) as the tooling region moves along the tool path. Implementing the constant ratio technique can help to ensure that the size of the tooling region remains constant (or that the size of the tooling region does not undesirably deviate away from a desired size) as the tooling region moves along the tool path.

In another embodiment, the aforementioned goal can be achieved by implementing a “constant speed” technique, which involves maintaining a constant (or at least substantially constant) tool power and tool speed as the tooling region moves along the tool path. The constant speed technique may be implemented by processing one or more actuator commands (each also referred to herein as a “raw actuator command”) that are obtained, or otherwise derived from, a computer file (e.g., a G-code computer file) or a computer program, before such actuator commands are input to the inverse kinematic transform 118 and processing 120 stages (e.g., of a control system such as control system 100 or 400) as one or more corresponding preliminary actuator commands. Accordingly, and with reference to FIG. 5, one or more raw actuator commands may be subjected to a pre-processing stage (also referred to herein as a “speed processing” stage 500), to produce a set of modified preliminary actuator commands (i.e., preliminary actuator commands X_prelim.′, Y_prelim.′, Z_prelim.′, B_prelim.′ and C_prelim.′).

As shown in FIG. 5, the raw actuator commands include the following raw linear actuator commands: raw X-axis actuator command (i.e., X_raw), raw Y-axis actuator command (i.e., Y_raw), and raw Z-axis actuator command (i.e., Z_raw); and raw rotary actuator commands: raw B-axis actuator command (i.e., B_raw) and raw C-axis actuator command (i.e., C_raw). For purposes of discussion, processing at the speed processing stage 500 is performed based on the assumption that the tool paths associated with the raw actuator commands contain only line segments, and it should be recognized that any curved portion of a tool path can be approximated with many short line segments. In should likewise be recognized that tool paths associated with the raw actuator commands may contain curved lines in addition to, or instead of, line segments.

Collectively, the raw actuator commands specify a sequence of tool tip and/or workpiece positions along X-, Y-, Z-, B- and C-axes for one or more segments of a tool path (each also referred to as a “raw tool path segment” or, more generically, a “tool path segment”) matching or otherwise corresponding to a desired trajectory. Accordingly, the tool tip or workpiece position can be characterized as an n-tuple, where n corresponds to the number of axes along which the multi-axis machine tool is capable of imparting movement. If the multi-axis machine tool is capable of imparting relative movement along the X-, Y-, Z-, B- and C-axes, or any combination thereof, then the tool tip or workpiece position can thus be characterized by the 5-tuple (xⱼ, yⱼ, zⱼ, bⱼ, cⱼ), where “x” corresponds to the position along the X-axis, “y” corresponds to the position along the Y-axis, “z” corresponds to the position along the Z-axis, “b” corresponds to the position along the B-axis and “c” corresponds to the position along the C-axis. Additionally, the subscript “j” is an integer identifying the location of the tool tip/workpiece position in the sequence of tool tip/workpiece positions. For example, (x₁, y₁, z₁, b₁, c₁) may characterize a first tool tip/workpiece position in a sequence of j tool tip/workpiece positions, (x₂, y₂, z₂, b₂, c₂) may characterize a second tool tip/workpiece position in the sequence of j tool tip/workpiece positions, (x₃, y₃, z₃, b₃, c₃) may characterize a third tool tip/workpiece position in the sequence of j tool tip/workpiece positions, etc. It will be appreciated that j can be any integer larger than 1 (e.g., greater than or equal to 2, 5, 10, 50, 100, 500, 1000, 2500, 5000, 10000, etc., or between any of these values). Any tool tip or workpiece position in the sequence of j tool tip/workpiece positions specified by the raw actuator commands may also be generically referred to herein as a “raw” position.

At the speed processing stage 500, the raw actuator commands are interpreted or otherwise processed to identify a start position and end position of each raw tool path segment. In one embodiment, any two sequentially-ordered raw positions in the sequence of j tool tip/workpiece positions can be considered as a pair of start and end positions. In this case, the first position in the pair of sequentially-ordered positions would be considered the raw “start position” and the second position in the pair of sequentially-ordered positions would be considered the raw “end position.” For example, the aforementioned first raw tool tip/workpiece position (x₁, y₁, z₁, b₁, c₁) can correspond to the raw start position of a first raw tool path segment associated with the raw actuator commands, and the aforementioned second raw tool tip/workpiece position (x₂, y₂, z₂, b₂, c₂) can correspond to the raw end position of the first raw tool path segment. Likewise, the aforementioned second raw tool tip/workpiece position (x₂, y₂, z₂, b₂, c₂) can correspond to the raw start position of a second raw tool path segment associated with the raw actuator commands, and the aforementioned third raw tool tip/workpiece position (x₃, y₃, z₃, b₃, c₃) can correspond to the raw end position of the second raw tool path segment.

The coordinate system for each raw start and end position, for each raw tool path segment, is transformed into a reference frame. In one embodiment, the reference frame is selected such that the positions B along the B- and C-axes are set to zero, so that each raw position can be characterized by a corresponding 3-tuple (xⱼ, yⱼ, zⱼ). Accordingly, the x, y, z, b and c coordinates of a raw start position can be transformed into the reference frame, according to the following equation:

$$[ \begin{matrix}x\_start \_ref \\ y\_start \_ref \\ z\_start \_ref\end{matrix} ] = [ \begin{matrix}cos ( c\_start \_raw ) & sin ( c\_start \_raw ) & 0 \\ - sin ( c\_start \_raw ) & cos ( c\_start \_raw ) & 0 \\ 0 & 0 & 1\end{matrix} ] \cdot [ \begin{matrix}cos ( b\_start \_raw ) & 0 & - sin ( b\_start \_raw ) \\ 0 & 1 & 0 \\ sin ( b\_start \_raw ) & 0 & cos ( b\_start \_raw )\end{matrix} ] \cdot [ \begin{matrix}x\_start \_raw \\ y\_start \_raw \\ z\_start \_raw\end{matrix} ] ,$$

where x_start_raw, y_start_raw, z_start_raw, b_start_raw and c_start_raw are the x, y, z, b and c coordinates, respectively, of a generic raw start position, and x_start_ref, y_start_ref and z_start_ref are the x, y and z coordinates, respectively, of a generic raw start position that has been transformed into the reference frame (i.e., a reference start position). Likewise, the x, y, z, b and c coordinates of a raw end position can be transformed into the reference frame, according to the following equation:

$$[ \begin{matrix}x\_end \_ref \\ y\_end \_ref \\ z\_end \_ref\end{matrix} ] = [ \begin{matrix}cos ( c\_end \_raw ) & sin ( c\_end \_raw ) & 0 \\ - sin ( c\_end \_raw ) & cos ( c\_end \_raw ) & 0 \\ 0 & 0 & 1\end{matrix} ] \cdot [ \begin{matrix}cos ( b\_end \_raw ) & 0 & - sin ( b\_end \_raw ) \\ 0 & 1 & 0 \\ sin ( b\_end \_raw ) & 0 & cos ( b\_end \_raw )\end{matrix} ] \cdot [ \begin{matrix}\begin{matrix}x\_end \_raw \\ y\_end \_raw\end{matrix} \\ z\_end \_raw\end{matrix} ] ,$$

where x_end_raw, y_end_raw, z_end_raw, b_start_raw and c_start_raw are the x, y, z, b and c coordinates, respectively, of a generic raw end position, and x_end_ref, y_end_ref and z_end_ref are the x, y and z coordinates, respectively, of a generic raw end position that has been transformed into the reference frame (i.e., a reference end position).

After transforming a pair of raw start and end positions into a corresponding pair of reference start and end positions, the number of servo cycles, n, required to impart relative movement between the tool tip and the workpiece from the reference start position to the reference end position, within each pair of reference start and end positions, is determined. In one embodiment, the number of servo cycles, n, is determined according to the following equation:

$$n = ( int ) ( \frac{t}{T} ) ,$$

where T, represents the duration of a servo cycle (typically measured in seconds, milliseconds or microseconds), and t, represents the time (i.e., the “segment time”) required to impart relative movement between the tool tip and the workpiece from the reference start position to the reference end position of a raw tool path segment. Generally, the servo cycle duration, T, is less than 1 millisecond. In some embodiments, Tis less than or equal to 750 μs, less than or equal to 500 μs, less than or equal to 250 μs, less than or equal to 100 μs, less than or equal to 75 μs, less than or equal to 50 μs, less than or equal to 25 μs, less than or equal to 10 μs, less than or equal to 5 μs, etc., or between any of these values. It should be recognized that the number of servo cycles, n, calculated for any raw tool path segment may be same or different from the number of servo cycles, n, calculated for any other raw tool path segment.

In one embodiment, the segment time, t, is determined according to the following equation:

t=d/V.

where d represents the distance (i.e., the “segment distance”) between each pair of reference start and end positions, and V represents the aforementioned tool speed. Generally, the tool speed may be predetermined or otherwise set (e.g., by a user or operator of the multi-axis machine tool) in accordance with the type of processing that is to be performed upon the workpiece by a contactless-type tool such as any of those described above. For example, when the contactless-type tool is provided as directed energy (e.g., in the form of laser light generated by a laser source), the tool speed can be in a range from 100 mm/sec to 7 m/sec when the tooling region moves along one or two axes, and can be in a range from 100 mm/sec to 700 mm/sec when the tooling region moves along three or more axes.

In one embodiment, the segment distance, d, can be determined according to the following equation:

$$d = \sqrt{\begin{matrix}{( x\_start \_ref - x\_end \_ref )}^{2} + {( y\_start \_ref - y\_end \_ref )}^{2} + \\ {( z\_start \_ref - z\_end \_ref )}^{2}\end{matrix}}$$

After determining the number of servo cycles, n, required to impart relative movement between the tool tip and the workpiece between a pair of reference start and end positions, the raw tool path segment having raw start and end positions which correspond to the pair of reference start and end positions is interpolated based on the determined number of servo cycles, n. Exemplary interpolation methods that may be used include linear interpolation, polynomial interpolation, spline interpolation, or the like or any combination thereof. If the interpolation performed is a linear interpolation, the distance between each pair of adjacent positions (raw or interpolated) along each axis (e.g., along each of the X-, Y-, Z-, B- and C-axes) is uniform (or at least substantially uniform).

In interpolating any particular raw tool path segment, one or more interpolated positions are inserted into the sequence of j tool tip/workpiece positions, between each pair of raw start and end positions for that particular raw tool path segment, based on the determined number of servo cycles, n. For example, assuming that the aforementioned first and second raw tool tip/workpiece positions (x₁, y₁, z₁, b₁, c₁) and (x₂, y₂, z₂, b₂, c₂), respectively, correspond to the start and end positions, respectively, of the aforementioned first raw tool path segment, and assuming that the determined number of servo cycles, n, is equal to 4, then the interpolation may produce three interpolated positions to be inserted into the sequence of j tool tip/workpiece positions, between the first and second raw tool tip/workpiece positions (x₁, y₁, z₁, b₁, c₁) and (x₂, y₂, z₂, b₂, c₂), respectively. In this example, the three interpolated positions may include a first interpolated tool tip/workpiece position (xᵢ₁, yᵢ₁, zᵢ₁, bᵢ₁, cᵢ₁), a second interpolated tool tip/workpiece position (xᵢ₂, yᵢ₂, zᵢ₂, bᵢ₂, cᵢ₂) and a third interpolated tool tip/workpiece position (xᵢ₃, yᵢ₃, zᵢ₃, bᵢ₃, cᵢ₃). Likewise, assuming that the aforementioned second and third raw tool tip/workpiece positions (x₂, y₂, z₂, b₂, c₂) and (x₃, y₃, z₃, b₃, c₃), respectively, correspond to the start and end positions, respectively, of the aforementioned second raw tool path segment, and assuming that the determined number of servo cycles, n, is equal to 3, then the interpolation may produce two interpolated tool tip/workpiece positions to be inserted into the sequence of j tool tip/workpiece positions, between the second and third raw tool tip/workpiece positions (x₂, y₂, z₂, b₂, c₂) and (x₃, y₃, z₃, b₃, c₃), respectively. In this example, the two interpolated positions may include a fourth interpolated tool tip/workpiece position (xᵢ₄, yᵢ₄, zᵢ₄, bᵢ₄, cᵢ₄) and a fifth interpolated tool tip/workpiece position (xᵢ₅, yᵢ₅, zᵢ₅, bᵢ₅, cᵢ₅).

After interpolating one or more raw tool path segments for each axis, the sequence of raw and interpolated positions is then output as the aforementioned preliminary actuator commands. For example, the sequence of raw and interpolated positions for the aforementioned first and second raw tool path segments along the X-axis (i.e., x₁, xᵢ₁, xᵢ₂, xᵢ₃, x₂, xᵢ₄, xᵢ₅, x₃) can be output as the modified preliminary X-axis actuator command (i.e., X_prelim.′), the sequence of raw and interpolated positions for the aforementioned first and second raw tool path segments along the Y-axis (i.e., y₁, yᵢ₁, yᵢ₂, yᵢ₃, y₂, yᵢ₄, yᵢ₅, y₃) can be output as the modified preliminary Y-axis actuator command (i.e., Y_prelim.′), the sequence of raw and interpolated positions for the aforementioned first and second raw tool path segments along the Z-axis (i.e., z₁, zᵢ₁, zᵢ₂, zᵢ₃, z₂, zᵢ₄, zᵢ₅, z₃) can be output as the modified preliminary Z-axis actuator command (i.e., Z_prelim.′), the sequence of raw and interpolated positions for the aforementioned first and second raw tool path segments along the B-axis (i.e., b₁, bᵢ₁, bᵢ₂, bᵢ₃, b₂, bᵢ₄, bᵢ₅, b₃) can be output as the modified preliminary B-axis actuator command (i.e., B_prelim.′) and the sequence of raw and interpolated positions for the aforementioned first and second raw tool path segments along the C-axis (i.e., c₁, cᵢ₁, cᵢ₂, cᵢ₃, c₂, cᵢ₄, cᵢ₅, c₃) can be output as the modified preliminary C-axis actuator command (i.e., C_prelim.′).

After interpolating one or more raw tool path segments for each axis, any pair of sequential raw or interpolated positions can be characterized as a start position and an end position of a tool path segment (also referred as a “processed tool path segment”). For example, the aforementioned first raw tool tip/workpiece position (x₁, y₁, z₁, b₁, c₁) can correspond to the start position of a first processed tool path segment, and the aforementioned first interpolated tool tip/workpiece position (xᵢ₁, yᵢ₁, zᵢ₁, bᵢ₁, cᵢ₁) can correspond to the end position of the first processed tool path segment. Likewise, the aforementioned first interpolated tool tip/workpiece position (xᵢ₁, yᵢ₁, zᵢ₁, bᵢ₁, cᵢ₁) can correspond to the start position of a second processed tool path segment, and the aforementioned first interpolated tool tip/workpiece position (xᵢ₂, yᵢ₂, zᵢ₂, bᵢ₂, cᵢ₂) can correspond to the end position of the second processed tool path segment. Etc.

Generally, the modified preliminary actuator commands for the X-, Y-, Z-, B- and C-axes are output in a coordinated manner, synchronized with respect to the servo cycle, n, such that sets of corresponding (raw or interpolated) positions, for each axis, can be processed together at the control system 100 or 400. In this case, the modified preliminary actuator commands X_prelim.′, Y_prelim.′, Z_prelim.′, B_prelim.′ and C_prelim.′ correspond to the aforementioned preliminary actuator commands X_prelim., Y_prelim., Z_prelim., B_prelim. and C_prelim., respectively. Thus, to continue with the example given above, for the n=1 servo cycle, the first raw tool tip/workpiece positions (x₁, y₁, z₁, b₁, c₁) can be output to the control system 100 or 400 (e.g., to the inverse kinematic transform 118 and processing 120) in the modified preliminary actuator commands X_prelim.′, Y_prelim.′, Z_prelim.′, B_prelim.′, C_prelim.′, respectively. For the n=2 servo cycle, the first interpolated position (xᵢ₁, yᵢ₁, zᵢ₁, bᵢ₁, cᵢ₁) can be output to the control system 100 or 400 (particularly, to the inverse kinematic transform 118 and processing 120) in the modified preliminary actuator commands X_prelim.′, Y_prelim.′, Z_prelim.′, B_prelim.′, C_prelim.′, respectively. For the n=3 servo cycle, the second interpolated position (xᵢ₂, yᵢ₂, zᵢ₂, bᵢ₂, cᵢ₂) can be output to the control system 100 or 400 (e.g., to the inverse kinematic transform 118 and the processing 120) in the modified preliminary actuator commands X_prelim.′, Y_prelim.′, Z_prelim.′, B_prelim.′, C_prelim.′, respectively, etc.

Actuator commands output by the process control system 100 or 400 (e.g., as discussed above), which were generated by processing the preliminary actuator commands output by the speed processing stage 500, enable the actuators of one or both of the workpiece positioning assembly and the tool-tip positioning assembly to move the tooling region along the tool path at a constant (or at least substantially constant) speed.

### V. Embodiments Concerning Positioning Assembly Adjustment

Moving the tooling region along a tool path at a constant (or at least substantially constant) tool speed can be desirable in many situations including, but not limited to, the situation described above (e.g., when it is desired to direct the energy or stream or jet of matter such that the directed energy or matter is applied evenly, or at least somewhat or substantially evenly, to the workpiece). The aforementioned constant speed technique can generally be used to produce features having straight lines or lines with relatively smooth curves (e.g., curves having continuously, first-order derivatives).

The constant speed technique can also be used to produce features having lines with relatively sharp curves or curved lines with a discontinuous derivative. In this case, however, the tool speed should be kept relatively low in order to stay within one or more constraints of the actuators in the multi-axis machine tool. In one embodiment, e.g., in the event that the tool speed would otherwise be kept so low as to undesirably affect the processing speed or throughput, the actuator commands output by the speed processing stage 500 can be processed according to a “repositioning” technique whereby a set of additional actuator commands (also referred to herein as “positioning assembly adjustment actuator commands”) are inserted into a sequence of preliminary actuator commands associated with a pair of sequential tool path segments. Unlike actuator commands associated with tool path segments, the tool is deactivated, disengaged or otherwise prevented from processing the workpiece when a set of positioning assembly adjustment actuator commands are output to the actuators of the multi-axis machine tool.

The positioning assembly adjustment technique may be implemented by first processing one or more actuator commands (e.g., the aforementioned set of modified preliminary actuator commands X_prelim.′, Y_prelim.′, Z_prelim.′, B_prelim. and C_prelim.′) before such actuator commands are input to the inverse kinematic transform 118 and processing 120 stages (e.g., of a control system such as control system 100 or 400) as one or more corresponding preliminary actuator commands. Accordingly, and with reference to FIG. 6, one or more modified preliminary actuator commands may be subjected to a pre-processing stage (also referred to herein as a “positioning assembly adjustment processing” stage 600), to produce another set of modified preliminary actuator commands (i.e., preliminary actuator commands X_prelim.″, Y_prelim.″, Z_prelim.″, B_prelim.″ and C_prelim.″).

At the positioning assembly adjustment processing stage 600, the modified preliminary actuator commands (e.g., X_prelim.′, Y_prelim.′, Z_prelim.′, B_prelim. and C_prelim.′) are interpreted or otherwise processed to determine whether movement from one process tool path segment (e.g., a first process tool path segment) in a sequence of process tool path segments to another process tool path segment (e.g., a second process tool path segment) in the sequence, along any particular axis (e.g., any of the X-, Y-, Z-, B- or C-axes), would exceed a threshold value (e.g., in terms of velocity, acceleration, jerk, or any combination thereof) associated with that particular axis. Accordingly, it is possible that the threshold value associated with one axis can be the same as, or different from, the threshold value associated with one or more other axes. Generally, the threshold value associated with a particular axis will correspond to the bandwidth of an actuator associated with the particular axis. If the multi-axis machine tool includes a set of redundant actuators associated with a particular axis, then the threshold value associated with the particular axis will correspond to the bandwidth of the actuator in the set of redundant actuators having the highest bandwidth.

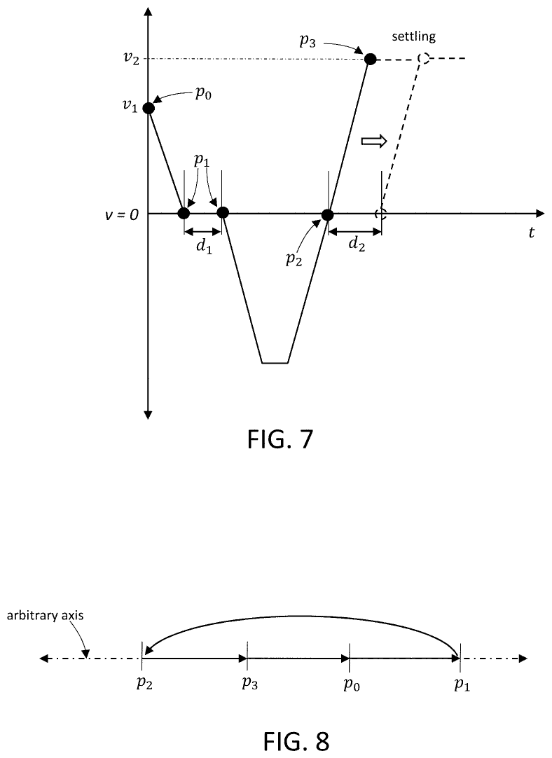

If it is determined that the threshold value for any axis would be exceeded then, for each of such axes, the positioning assembly adjustment processing stage 600 analyzes the preliminary actuator command associated with that axis to: (a) determine a distance (i.e., a “deceleration distance”) required to decelerate (e.g., from a first speed, v₁, as shown in FIG. 7) along the axis to a full stop (e.g., to speed v=0, as shown in FIG. 7) without exceeding a threshold value associated with the axis; (b) determine a distance (i.e., an “acceleration distance”) required to accelerate along the axis to a desired speed (e.g., to a second speed, v₂, as shown in FIG. 7) along the axis without exceeding a threshold value associated with the axis; and (c) determine the minimum distance (i.e., the “settling distance”) to be traversed along the axis at the desired speed (e.g., at the second speed, v₂, as shown in FIG. 7) until all actuators associated with the axis will have suitably settled.

Typically, the deceleration distance corresponds to a distance over which maximum deceleration can be achieved, but the deceleration distance may correspond to a distance over which only slight or moderate deceleration is achieved. Likewise, the acceleration distance corresponds to a distance over which maximum acceleration can be achieved, but the acceleration distance may correspond to a distance over which only slight or moderate acceleration is achieved. Moreover, deceleration or acceleration may be achieved using one or more constant deceleration or acceleration profiles, one or more variable deceleration or acceleration profiles, or any combination thereof. In one embodiment, the settling distance can be determined according to the following equation:

settling distance=v₂*tₛₑₜₜₗₑ,

where tₛₑₜₜₗₑ represents the shortest settling time of any actuator associated with the axis.

Next, positions along the axis are computed based on the deceleration distance, acceleration distance and settling distance, determined as described above. These positions include: (a) the position offset from the end position of the first process tool path segment by the deceleration distance (i.e., the deceleration position); and (b) the position offset from the end position of the first process tool path segment by the sum of the acceleration distance and the settling distance (i.e., the move-back position). The aforementioned end position of the first process tool path segment, deceleration position, and move-back position are illustrated in FIGS. 7 and 8 at p₀, p₁ and p₂, respectively and, as shown in FIG. 8, are separated from one another along a common axis. It should be recognized that the end position, p₀, of the first process tool path segment also represents the start position of the second process tool path segment. As shown in FIG. 8, the deceleration distance is the distance along the axis, between the end position, p₀, of the first process tool path segment and the deceleration position, p₁. Likewise, the sum of the acceleration distance and the settling distance is the distance along the axis, between the end position, p₀, of the first process tool path segment and the move-back position, p₂. In FIGS. 7 and 8, position p₃ indicates the position (i.e., the desired speed position) along the axis at which the desired speed (e.g., the second speed, v₂, as shown in FIG. 7) is first achieved (i.e., upon accelerating from the move-back position, p₂). The distance between the desired speed position, p₃, and the start position of the second process tool path segment (i.e., position, p₀) corresponds to the aforementioned settling distance.

As mentioned above, the tool is deactivated, disengaged or otherwise prevented from processing the workpiece when actuator commands corresponding to the set of positioning assembly adjustment actuator commands are output to the actuators of the multi-axis machine tool. After actuator commands corresponding to the set of positioning assembly adjustment actuator commands are output to the actuators, the tool is re-activated, re-engaged or otherwise permitted to process the workpiece. When the deceleration position, p₁, and the move-back position, p₂, are determined for one axis as discussed above, the deceleration and move-back positions of one or more other axes may also be determined (e.g., as discussed above), even if a threshold value would not be exceeded for any of those other axes, to ensure that the tooling region is accurately aligned to the start position of the second process tool path segment (as well as to the second process tool path segment itself) by the time the tool is re-activated, re-engaged or otherwise permitted to process the workpiece. Thus, actuator commands corresponding to the set of positioning assembly adjustment actuator commands can command any actuator associated with any of such other axes to move along their associated axes, to their respective deceleration, move-back and second process tool path start positions, p₁, p₂, and p₀, respectively, in the manner as discussed above.

Once generated, the set of positioning assembly adjustment actuator commands is inserted into the modified preliminary actuator commands (e.g., X_prelim.′, Y_prelim.′, Z_prelim.′, B_prelim. and C_prelim.′), thereby producing another set of modified preliminary actuator commands (i.e., preliminary actuator commands X_prelim.″, Y_prelim.″, Z_prelim.″, B_prelim.″ and C_prelim.″), which can then be output as the aforementioned preliminary actuator commands. Generally, the set of positioning assembly adjustment actuator commands is inserted into the modified preliminary actuator commands in a coordinated manner such that second process tool path start positions, p₀, for each axis can be processed together at the control system 100 or 400. Thus, the set of positioning assembly adjustment actuator commands is inserted into the modified preliminary actuator commands such that second process tool path start positions, p₀, for each of the axes is temporally aligned with one another.

In one embodiment, the positioning assembly adjustment processing stage 600 may temporally align the second process tool path start positions, p₀, for each axis by dwelling at the deceleration position, p₁, along any axis for a dwell time (e.g., a first dwell time, d₁, as shown in FIG. 7), so that the move-back position, p₂, for each of the axes is temporally aligned with one another. In another embodiment, the positioning assembly adjustment processing stage 600 may temporally align the second process tool path start positions, p₀, for each axis by dwelling at the move-back position, p₂, along any axis for a dwell time (e.g., a second dwell time, d₂, as shown in FIG. 7), so that the second process tool path start position, p₀, for each of the axes is temporally aligned with one another.

### VI. Further Embodiments Concerning Error Correction

The multi-axis machine tools described herein employ both linear and rotary actuators to impart relative movement between the tool tip and the workpiece. Any errors in movement introduced by the actuators has the potential to cause the tooling region to move along a tool path that deviates undesirably from the desired trajectory. In some embodiments, actuators such as the relatively-low bandwidth X-axis actuator 102, the relatively-low bandwidth Y-axis actuator 104, the relatively-low bandwidth Z-axis actuator 106, the B-axis actuator 114 and the C-axis actuator 116 are provided as servo systems. Generally, a servo system will have error-sensing negative feedback to correct for tracking errors associated with the servo system. As long as the tracking error does not exceed specifications for the multi-axis machine tool, the tracking errors are tolerated. However, the tracking errors can grow as the actuators of the multi-axis machine tool machining tool are driven more aggressively (e.g., as the actuators are driven with larger acceleration rates, with actuator commands having higher frequency content, etc.).

In view of the above, an error correction technique may be implemented, whereby one or more of the relatively-high bandwidth actuators is used to compensate for tracking errors associated with one or more of the relatively-low bandwidth actuators or rotary actuators of the multi-axis machine tool. Although an embodiment of the error correction technique is described below in connection with any multi-axis machine tool as disclosed herein, it should be recognized that the error correction technique may be implemented with any other machine tool having one or more sets of redundant actuators, one or more sets of axially-complementary actuators, or any combination thereof.

Generally, the error correction technique is a real-time error correction technique. The errors that can be compensated for come from two sources. The first error source is the difference between a position specified in one or more low-frequency content linear actuator commands, each output to a relatively-low bandwidth actuator (e.g., the relatively-low bandwidth X-axis actuator 102, the relatively-low bandwidth Y-axis actuator 104 or the relatively-low bandwidth Z-axis actuator 106), and the actual position to which the relatively-low bandwidth actuator moved (as represented by a feedback signal associated with the relatively-low bandwidth actuator). The second error source is the difference between a position specified in one or more low-frequency content rotary actuator commands, each output to a rotary actuator (e.g., the B-axis actuator 114 or the C-axis actuator 116), and the actual position to which the rotary actuator moved (as represented by a feedback signal associated with the rotary actuator).

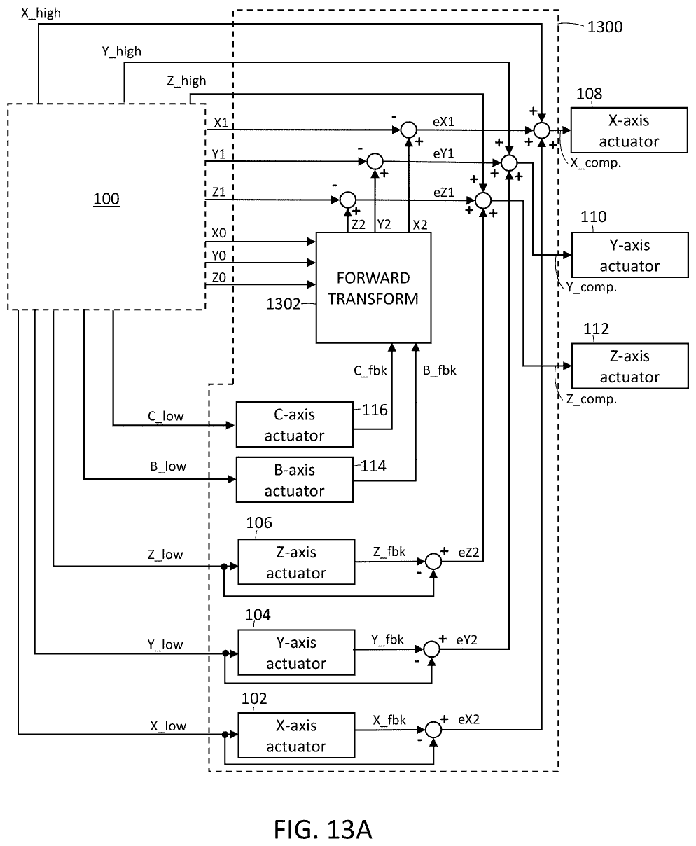

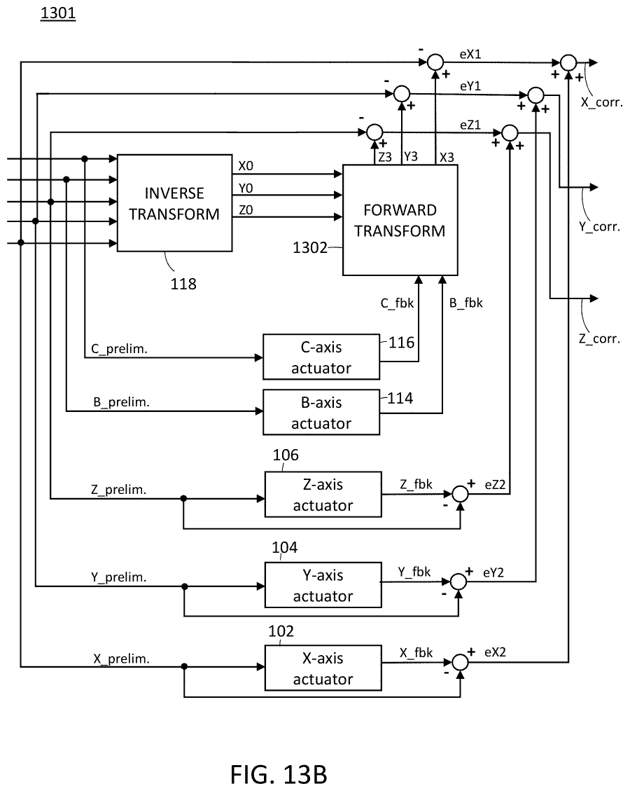

FIG. 13A is a block diagram schematically illustrating an embodiment of a real-time error correction system 1300, for implementing an error correction technique discussed above. Generally, the real-time error correction system 1300 implements the error correction technique by feeding errors associated with the relatively-low bandwidth actuators into one or more of the relatively-high bandwidth actuators (e.g., to one or more of the relatively-high bandwidth X-axis actuator 108, the relatively-high bandwidth Y-axis actuator 110, and the relatively-high bandwidth Z-axis actuator 112) for correction. Further, errors associated with the rotary actuators are, initially, converted into corresponding linear errors, and the linear errors are then fed into one or more of the relatively-high bandwidth actuators. The error correction technique addresses the combined effects of the first and second error sources and helps to improve dynamic accuracy of the multi-axis machine tool in real time.

Referring to FIG. 13A, the real-time error correction system 1300 can be characterized as taking, as inputs, certain commands generated by the control system 100. For example, in the illustrated embodiment, the real-time error correction system 1300 may take, as inputs, the first set of intermediate linear actuator commands (i.e., the first intermediate X-axis actuator command, X0, the first intermediate Y-axis actuator command, Y0, and the first intermediate Z-axis actuator command, Z0), the second set of intermediate linear actuator commands (i.e., the second intermediate X-axis actuator command, X1, the second intermediate Y-axis actuator command, Y1, and the second intermediate Z-axis actuator command, Z1), the processed rotary actuator commands (i.e., B_low and C_low), the first set of processed linear actuator commands (i.e., the low-frequency content X-axis actuator command, X_low, the low-frequency content Y-axis actuator command, Y_low, and the low-frequency content Z-axis actuator command, Z_low) and the second set of processed linear actuator commands (i.e., the high-frequency content X-axis actuator command, X_high, the high-frequency content Y-axis actuator command, Y_high, and the high-frequency content Z-axis actuator command, Z_high).

The first set of intermediate linear actuator commands and rotary feedback signals generated by (or otherwise associated with) the B-axis rotary actuator 114 and the C-axis rotary actuator 116 (i.e., B_fbk and C_fbk, respectively) are processed to generate a third set of intermediate linear actuator commands. For example, a forward kinematic transform 1302 is applied to the first intermediate X-axis actuator command (i.e., X0), the first intermediate Y-axis actuator command (i.e., Y0), the first intermediate Z-axis actuator command (i.e., Z0), the B-axis rotary feedback signal (i.e., B_fbk) and the C-axis rotary feedback signal (i.e., C_fbk) to generate the third set of intermediate linear actuator commands. The third set of intermediate linear actuator commands includes a third intermediate X-axis actuator command (i.e., X2), a third intermediate Y-axis actuator command (i.e., Y2) and a third intermediate Z-axis actuator command (i.e., Z2). The forward kinematic transform can be applied according to the following equation:

$$[ \begin{matrix}X 2 \\ Y 2 \\ Z 2\end{matrix} ] = [ \begin{matrix}cos ( B\_fbk ) & 0 & sin ( B\_fbk ) \\ 0 & 1 & 0 \\ - sin ( B\_fbk ) & 0 & cos ( B\_fbk )\end{matrix} ] \cdot [ \begin{matrix}cos ( C\_fbk ) & - sin ( C\_fbk ) & 0 \\ sin ( C\_fbk ) & cos ( C\_fbk ) & 0 \\ 0 & 0 & 1\end{matrix} ] \cdot [ \begin{matrix}X 0 \\ Y 0 \\ Z 0\end{matrix} ]$$

As shown in the equation above, the forward kinematic transform computes the third set of intermediate linear actuator commands at the actual feedback positions along the B- and C-axes.

The difference between respective ones of the second and third sets of intermediate linear actuator commands are manifested as a set of first linear error signals (i.e., first linear error signals eX1, eY1 and eZ1) representing the linear errors caused by tracking errors of one or more of the rotary actuators (e.g., one or more of the B-axis actuator 114 and the C-axis actuator 116). Each of the first linear error signals eX1, eY1 and eZ1 is combined with a corresponding second linear error signal eX2, eY2 and eZ2 (collectively referred to as a “set of second linear errors”), which represent the linear errors caused by tracking errors of one or more of the relatively-low bandwidth linear actuators (e.g., one or more of the relatively-low bandwidth X-axis actuator 102, the relatively-low bandwidth Y-axis actuator 104 and the relatively-low bandwidth Z-axis actuator 106). As shown, each second linear error signal (eX2, eY2 and eZ2) corresponds to the difference between a position commanded by an actuator command output to an actuator and a position indicated by the feedback signal generated by the actuator. Accordingly, upon reacting to the low-frequency content X-axis actuator command (i.e., X_low), the low-frequency content Y-axis actuator command (i.e., Y_low) and the low-frequency content Z-axis actuator command (i.e., Z_low), the relatively-low bandwidth X-axis actuator 102, the relatively-low bandwidth Y-axis actuator 104 and the relatively-low bandwidth Z-axis actuator 106 generate feedback signals X_fbk, Y_fbk and Z_fbk, respectively.

In the embodiment illustrated in FIG. 13A, each of the combined first and second linear error signals (i.e., eX1+eX2, eY1+eY2 and eZ1+eZ2) is also combined with the second set of processed linear commands (i.e., the high-frequency content X-axis actuator command, X_high, the high-frequency content Y-axis actuator command, Y_high, and the high-frequency content Z-axis actuator command, Z_high), to thereby generate a third set of processed linear commands. Because the third set of processed linear commands are derived from the first and second linear error signals, as well as from the second set of processed linear commands, the frequency content of the third set of processed linear commands can be mixed (i.e., including frequency content that is below or at, as well as above, the threshold frequency of any of the rotary actuators and the relatively-low bandwidth linear actuators). Thus, the third set of processed linear commands can include a compound X-axis actuator command (i.e., X_comp.), a compound Y-axis actuator command (i.e., Y_comp.) and a compound Z-axis actuator command (i.e., Z_comp.). The compound X-axis actuator command (i.e., X_comp.) has frequency content spanning a range of frequencies from below threshold frequency of the relatively-low bandwidth X-axis actuator 102 to above the threshold frequency of the relatively-low bandwidth X-axis actuator 102. Likewise, the compound Y-axis actuator command (i.e., Y_comp.) has frequency content spanning a range of frequencies from below threshold frequency of the relatively-low bandwidth Y-axis actuator 104 to above the threshold frequency of the relatively-low bandwidth Y-axis actuator 104; and the compound Z-axis actuator command (i.e., Z_comp.) has frequency content spanning a range of frequencies from below threshold frequency of the relatively-low bandwidth Z-axis actuator 106 to above the threshold frequency of the relatively-low bandwidth Z-axis actuator 106.

Ultimately, and as shown, the compound X-axis actuator command (i.e., X_comp.), the compound Y-axis actuator command (i.e., Y_comp.) and the compound Z-axis actuator command (i.e., Z_comp.) are output, respectively, to the relatively-high bandwidth X-axis actuator 108, the relatively-high bandwidth Y-axis actuator 110 and the relatively-high bandwidth Z-axis actuator 112. As illustrated in FIG. 13A, the third set of processed linear commands are output to the relatively-high bandwidth actuators instead of the second set of processed linear commands (i.e., X_high, Y_high and Z_high).

According to the embodiment illustrated in FIG. 13A, the real-time error correction system 1300 is implemented with the control system 100. As described above, the control system 100 can be characterized as implementing an algorithm for processing and generating suitable actuator commands to control a multi-axis machine tool whereby the frequency content of preliminary actuator commands is decomposed into multiple frequency bands corresponding to the threshold frequencies of the actuators included in the multi-axis machine tool. It will be appreciated, however, that the real-time error correction system 1300, or variations thereof, may be implemented with any other type of control system.

For example, a real-time error correction system may be implemented with a control system that does not decompose the frequency content of the preliminary actuator commands into multiple frequency bands as discussed above. For example, the control system may simply generate and output the aforementioned preliminary actuator commands. In this example, a variant of the real-time error correction system 1300 may be provided as real-time error correction system 1301, as exemplarily illustrated in FIG. 13B.

Referring to FIG. 13B, the real-time error correction system 1301 may be configured to process preliminary actuator commands (e.g., the aforementioned preliminary actuator commands X_prelim., Y_prelim., Z_prelim., B_prelim., C_prelim.) to generate a set of intermediate linear actuator commands (e.g., the aforementioned first set of intermediate linear actuator commands X0, Y0 and Z0) by applying an inverse kinematic transform (e.g., aforementioned inverse kinematic transform 118).

The preliminary actuator commands are also output to respective ones of the rotary actuators of the multi-axis machine tool, and respective feedback signals are generated. For example, the preliminary X-axis actuator command (i.e., X_prelim.) is output to the relatively-low bandwidth X-axis actuator 102, the preliminary Y-axis actuator command (i.e., Y_prelim.) is output to the relatively-low bandwidth Y-axis actuator 104, the preliminary Z-axis actuator command (i.e., Z_prelim.) is output to the relatively-low bandwidth Z-axis actuator 106, the preliminary B-axis actuator command (i.e., B_prelim.) is output to the B-axis actuator 114 and the preliminary C-axis actuator command (i.e., C_prelim.) is output to the relatively-low bandwidth C-axis actuator 116. The aforementioned actuators may, in turn, generate and output corresponding feedback signals (e.g., the aforementioned feedback signals X_fbk, Y_fbk, Z_fbk, B_fbk and C_fbk).

The first set of intermediate linear actuator commands (e.g., X0, Y0 and Z0) and rotary feedback signals (e.g., B_fbk and C_fbk) are processed, along with the preliminary X-axis actuator command (i.e., X_prelim.), the preliminary Y-axis actuator command (i.e., Y_prelim.) and the preliminary Z-axis actuator command (i.e., Z_prelim.), to generate another set of intermediate linear actuator commands (e.g., a fourth set of intermediate linear actuator commands X3, Y3 and Z3) by applying a forward kinematic transform (e.g., the aforementioned forward kinematic transform 1302).

The real-time error correction system 1301 computes the difference between respective ones of the preliminary linear actuator commands (i.e., the preliminary X-axis actuator command, X_prelim., the preliminary Y-axis actuator command, Y_prelim., and preliminary Z-axis actuator command, Z_prelim.) and the fourth set of intermediate linear actuator commands (i.e., X3, Y3 and Z3) to derive the aforementioned set of first linear error signals (i.e., eX1, eY1 and eZ1). Likewise, the difference between a position commanded by each actuator command output to an actuator and a position indicated by the feedback signal generated by the actuator is computed to derive the aforementioned set of second linear error signals (i.e., eX2, eY2 and eZ2).

Each of the first linear error signals eX1, eY1 and eZ1 is combined with a corresponding second linear error signal eX2, eY2 and eZ2, and each of the combined first and second linear error signals (i.e., eX1+eX2, eY1+eY2 and eZ1+eZ2) is then output to corresponding ones of the relatively-high bandwidth actuators as a fourth set of processed linear commands. The fourth set of processed linear commands can include an error correction X-axis actuator command, X_corr., an error correction Y-axis actuator command, Y_corr., and an error correction Z-axis actuator command, Z_corr. The error correction X-axis actuator command (i.e., X_corr.), the error correction Y-axis actuator command (i.e., Y_corr.) and the error correction Z-axis actuator command (i.e., Z_corr.) are output, respectively, to the relatively-high bandwidth X-axis actuator 108, relatively-high bandwidth Y-axis actuator 110, relatively-high bandwidth Z-axis actuator 112, B-axis actuator 114 and C-axis actuator 116.

### VII. Further Embodiments Concerning Relatively-High Bandwidth Z-Axis Actuator

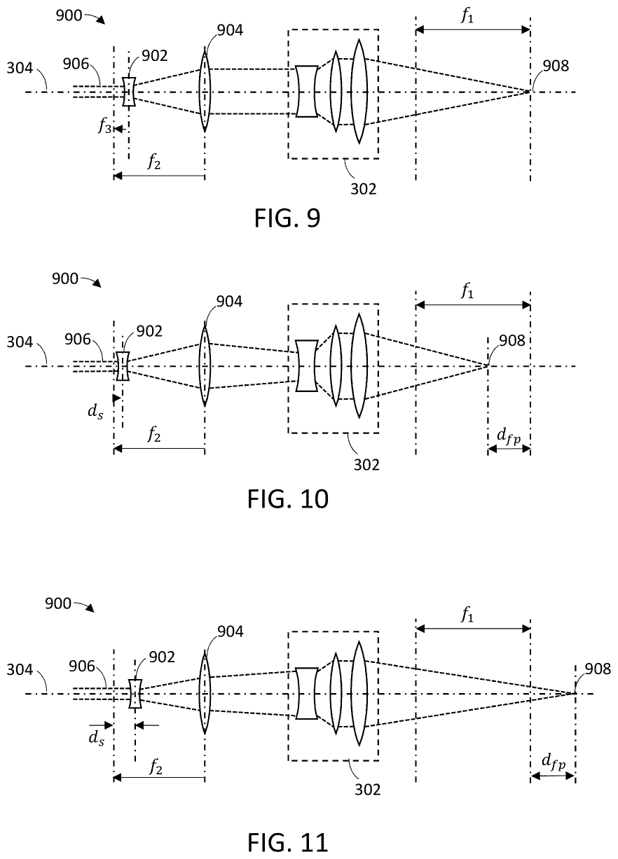

As mentioned above with respect to the parallel tool tip positioning assembly, if the tool is to be provided as a focused beam of laser light, then the relatively high-bandwidth Z-axis actuator 112 can be provided as a zoom lens disposed in a path along which the laser light propagates (i.e., the “propagation path”). As will be understood by one of ordinary skill, a zoom lens is a mechanical assembly of lens elements, for which the focal length can be varied. FIG. 9 illustrates a zoom lens according to one embodiment, which may be used as the relatively high-bandwidth Z-axis actuator 112.

Referring to FIG. 9, a zoom lens according to one embodiment may be provided as zoom lens 900, and include an objective lens element 902 (e.g., a diverging lens element) and a converging lens element 904. In the illustrated embodiment, the objective lens element 902 is provided as a diverging lens (e.g., a double-concave lens), and the converging lens element 904 is provided as a double-convex lens. Although the objective lens element 902 and converging lens element 904 are illustrated as single-lens systems, it will be appreciated that one or both of the objective lens element 902 and converging lens element 904 may be provided as a compound-lens system as is known in the art.

The objective lens element 902 and converging lens element 904 are both arranged along a common axis (e.g., collinear with the propagation path, such as aforementioned propagation path 304) in any suitable manner known in the art. Generally, the scan lens 302 can be characterized as having a first focal length, f₁, the converging lens element 904 can be characterized as having a second focal length, f₂ (i.e., measured from the axis of the converging lens element 904) and the objective lens element 902 can be characterized as having a third focal length, f₃, (i.e., measured from the axis of the objective lens element 902). Generally, the first focal length, f₁, is greater than the second focal length, f₂, and the second focal length, f₂, is greater than the third focal length, f₃.

Further, and although not shown, the objective lens element 902 may be coupled to an actuator (e.g., one or more hydraulic cylinders, one or more pneumatic cylinders, one or more servo motors, one or more voice-coil actuators, one or more piezoelectric actuators, one or more electrostrictive elements, one or more galvanometer-driven cams, or the like or any combination thereof) arranged and configured to move the objective lens element 902 along the propagation path 304, relative to the converging lens element 904. For example, this actuator (also referred to herein as a “zoom lens actuator”) may move the objective lens element 902 away from the converging lens element 904 or toward the converging lens element 904. In some embodiments, the zoom lens actuator may be configured to move the objective lens element 902 toward or away from the converging lens element 904 by a distance of at least 1 mm, at least 5 mm, at least 10 mm, at least 15 mm, at least 20 mm, at least 25 mm, at least 30 mm, at least 40 mm, at least 50 mm, at least 75 mm, etc., or between any of these values. The converging lens element 904 may be positionally fixed relative to the scan lens 302, or may be movable relative to the scan lens 302.

The zoom lens 900 is arranged optically upstream of a scan lens (e.g., provided as the aforementioned scan lens 302). Although not shown, a relatively-high bandwidth X-axis actuator 108 and a relatively-high bandwidth Y-axis actuator 110 (e.g., each provided as a galvanometer-driven mirror system, such as the aforementioned first and second galvanometer-driven mirror systems discussed with respect to FIG. 3) may be interposed between the zoom lens 900 and the scan lens 302.

As shown in FIG. 9, the zoom lens actuator may be operated to position the objective lens element 902 at a “zero-shift position,” such that the focal plane of the objective lens element 902 (i.e., at the third focal length, f₃) coincides with the focal plane of the converging lens element 904 (i.e., at the second focal length, f₂). When the objective lens element 902 is positioned as discussed above (i.e., at the “zero-shift position”), a beam of laser light 906, after having propagated through the zoom lens 900, is focused by the scan lens 302 at a focal point 908 that coincides with the focal plane of the scan lens 302 (i.e., at the first focal length, f₁).

As shown in FIG. 10, the zoom lens actuator may be operated to shift the objective lens element 902 away from the zero-shift position, in a direction moving away from the converging lens element 904, such that the focal plane of the objective lens element 902 (i.e., at the third focal length, f₃) moves away from the focal plane of the converging lens element 904 (i.e., at the second focal length, f₂) in a direction away from the converging lens element 904. When the objective lens element 902 is positioned as discussed above (i.e., at a “positive-shift position”), the focal point 908 of the beam of laser light 906 (after having propagated through the zoom lens 900 and focused by the scan lens 302) is shifted toward the scan lens 302. As shown in FIG. 10, between the zoom lens 900 and the scan lens 302, the beam of laser light 906 converges as it propagates toward the scan lens 302.

As shown in FIG. 11, the zoom lens actuator may be operated to shift the objective lens element 902 away from the zero-shift position, in a direction moving towards the converging lens element 904, such that the focal plane of the objective lens element 902 (i.e., at the third focal length, f₃) moves away from the focal plane of the converging lens element 904 (i.e., at the second focal length, f₂) in a direction towards the converging lens element 904. When the objective lens element 902 is positioned as discussed above (i.e., at a “negative-shift position”), the focal point 908 of the beam of laser light 906 (after having propagated through the zoom lens 900 and focused by the scan lens 302) is shifted away from the scan lens 302. As shown in FIG. 11, between the zoom lens 900 and the scan lens 302, the beam of laser light 906 diverges as it propagates toward the scan lens 302.

The distance, d_{fp}, by which the focal point 908 is shifted either toward the scan lens 302 (as shown in FIG. 10) or away from the scan lens 302 (as shown in FIG. 11) can be determined according to the following equation:

$${d}_{fp} = ( {d}_{s} - {f}_{3} ) * {( \frac{{f}_{1}}{{f}_{2}} )}^{2} ,$$

where dₛ is equal to the distance from the axis of the objective lens element 902, as shifted, and the focal plane of the converging lens element 904. As discussed above, f₁ represents the focal length of the scan lens 302, f₂ represents the focal length of the converging lens element 904 and f₃ represents the focal length of the objective lens element 902. It should be recognized that f₁, f₂ and f₃ may be selected or otherwise set to ensure that a ratio in the shift distance, dₛ, of the objective lens element 902 to the shift distance, d_{fp}, of the focal point 908, can be equal to 1:1, greater than 1:1, or less than 1:1. Shifting of the focal point 908 as described herein may also be referred to herein as “focus height modulation.”

Further, characteristics of the objective lens element 902, the converging lens element 904 and the scan lens 302 can be selected such that the spot size of the focused beam of laser light ultimately delivered to the tooling region of the workpiece (i.e., after having been propagated through the zoom lens 900 and scan lens 302, as discussed above) varies by less than 1 μm as the shift distance, dₛ, of the objective lens element 902 is scanned from a maximum positive-shift position to a maximum negative-shift position. In some embodiments, the variation in spot size of the focused beam of laser light ultimately delivered to the tooling region of the workpiece (i.e., after having been propagated through the zoom lens 900 and scan lens 302, as discussed above) may vary by less than 0.75 μm, less than 0.5 μm, less than 0.25 μm, less than 0.1 μm, less than 0.075 μm, less than 0.05 μm, less than 0.025 μm, less than 0.01 μm, etc., or between any of these values, as the shift distance, dₛ, of the objective lens element 902 is scanned from a maximum positive-shift position to a maximum negative-shift position.

As used herein, the term “spot size” refers to the diameter or maximum spatial width of a delivered laser pulse at a location where the tooling axis traverses the tooling region of the workpiece. For purposes of discussion herein, spot size is measured as a radial or transverse distance from the tooling axis to where the optical intensity drops to, at least, 1/e² of the optical intensity at the tooling axis.

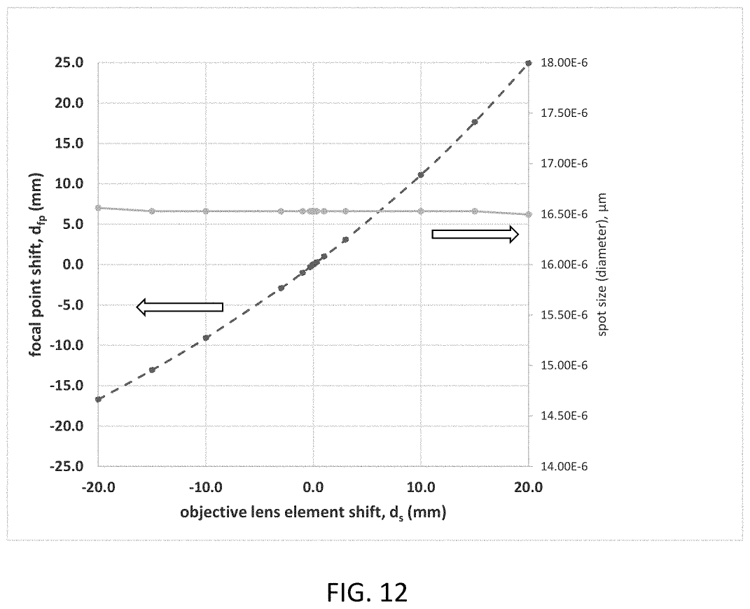

FIG. 12 illustrates a graph showing results of an experiment by which the shift distance, dₛ, of the objective lens element 902 was scanned from a maximum positive-shift position of 20 mm to a maximum negative-shift position of 20 mm, resulting in a corresponding shift in shift distance, d_{fp}, of the focal point 908 as shown by the dashed line (associated with the left-illustrated vertical axis) and a variability on spot size of the focused beam of laser light ultimately delivered to the tooling region of the workpiece (i.e., a surface of the workpiece) of about 0.066 μm, as shown by the grey solid line (associated with the right-illustrated vertical axis).

Constructed as described above, the zoom lens 900 provides well-controlled focus height modulation over a limited range (e.g., about +/−10% of the first focal length) with minimal effect on focal plane flatness of the scan lens 302, spot size at the focal point 908, spot shape at the focal point 908, and telecentricity. Moreover, the objective lens element 902 weighs only a few grams, thereby permitting the zoom lens actuator to move the objective lens element 902 at a much higher bandwidth than the relatively-low bandwidth Z-axis actuator 106.

### VIII. Example Embodiment of a Hybrid Multi-Axis Machine Tool

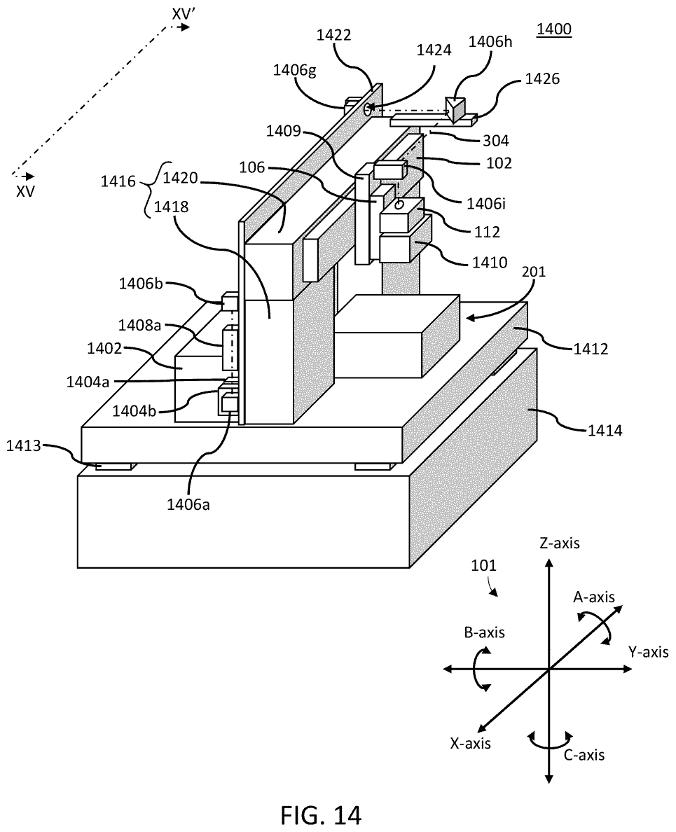

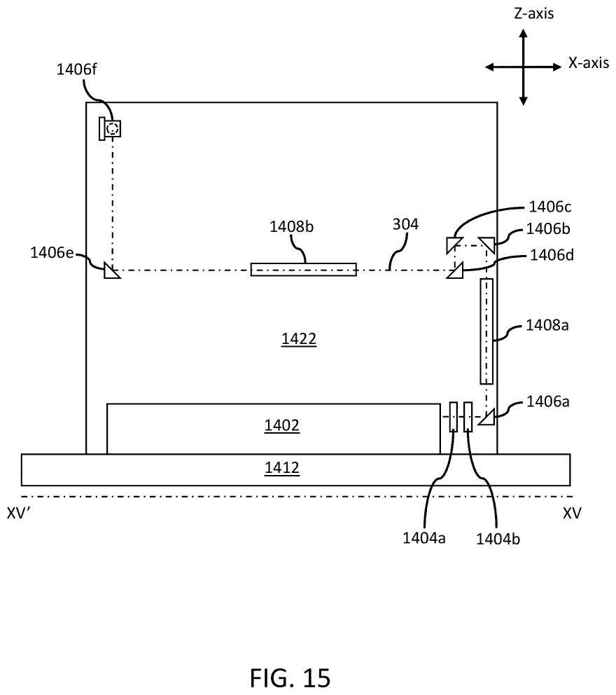

FIG. 14 is a perspective view schematically illustrating a hybrid multi-axis machine tool according to one embodiment. FIG. 15 is a partial side plan view schematically illustrating the hybrid multi-axis machine tool shown in FIG. 14, taken along line XV-XV′ in FIG. 14.

Referring to FIGS. 14 and 15, a hybrid multi-axis machine tool, such as multi-axis machine tool 1400, may include components such as a laser source 1402 for generating laser light (e.g., manifested as a series of pulses, as a continuous or quasi-continuous beam of laser light, or any combination thereof), and laser optics for conditioning (e.g., expanding, collimating, filtering, polarizing, focusing, attenuating, scattering, absorbing, reflecting, or the like or any combination thereof) laser light generated by the laser source 1402. Examples of laser optics may be provided include one or more shutters, such as first and second optical shutters 1404a and 1404b, respectively, first, second, third, fourth, fifth, sixth, seventh, eighth and ninth fold mirrors 1406a, 1406b, 1406c, 1406d, 1406e, 1406f, 1406g, 1406h and 1406i, respectively, and first and second collimators 1408a and 1408b, respectively.

Generally, the laser source 1402 is operative to generate laser light. As such, the laser source 104 may include a pulse laser source, a CW laser source, a QCW laser source, a burst mode laser, or the like or any combination thereof. In the event that the laser source 1402 includes a QCW or CW laser source, the laser source 104 may, optionally, include a pulse gating unit (e.g., an acousto-optic (AO) modulator (AOM), a beam chopper, etc.) to temporally modulate beam of laser radiation output from the QCW or CW laser source (e.g., to produce one or more laser pulses). Although not illustrated, the multi-axis machine tool 1400 may optionally include one or more harmonic generation crystals (also known as “wavelength conversion crystals”) configured to convert a wavelength of light output by the laser source 1402. Accordingly, laser light ultimately delivered to a workpiece supported by the workpiece positioning assembly 201 may be characterized as having one or more wavelengths in one or more of the ultra-violet (UV), visible (e.g., violet, blue, green, red, etc.), or infrared (IR) ranges of the electromagnetic spectrum, or any combination thereof.

Laser pulses ultimately delivered to a workpiece supported by the workpiece positioning assembly 201 can have a pulse width or pulse duration (i.e., based on the full-width at half-maximum (FWHM) of the optical power in the pulse versus time) that is in a range from 10 fs to 900 ms. Laser pulses output by the laser source 1402 can have an average power in a range from 100 mW to 50 kW. It will be appreciated, however, that the average power can be made smaller than 100 mW or larger than 50 kW. Laser pulses can be output by the laser source 1402 at a pulse repetition rate in a range from 5 kHz to 1 GHz. It will be appreciated, however, that the pulse repetition rate can be less than 5 kHz or larger than 1 GHz. Examples of types of lasers that the laser source 1402 may be characterized as gas lasers (e.g., carbon dioxide lasers, carbon monoxide lasers, excimer lasers, etc.), solid-state lasers (e.g., Nd:YAG lasers, etc.), rod lasers, fiber lasers, photonic crystal rod/fiber lasers, passively mode-locked solid-state bulk or fiber lasers, dye lasers, mode-locked diode lasers, pulsed lasers (e.g., ms-, ns-, ps-, fs-pulsed lasers), CW lasers, QCW lasers, or the like or any combination thereof.

In one embodiment, one or both of the first and second optical shutters 1404a and 1404b, respectively, may be provided as a manually- or controller-actuated iris that may be opened or closed, in any manner known in the art, to control the amount of light that passes through an aperture of the iris. In one embodiment, one or both of the first and second collimators 1408a and 1408b, respectively, may be provided as a beam-reducing or beam-expanding collimator.

The multi-axis machine tool 1400 further includes a workpiece positioning assembly. In one embodiment, the workpiece positioning assembly is provided as the aforementioned workpiece positioning assembly 201, and the tool tip positioning assembly is provided as a hybrid tool tip positioning assembly. Accordingly, the workpiece positioning assembly 201 may include a relatively-low bandwidth Y-axis actuator 104, B-axis actuator 114 and C-axis actuator 116 (e.g., where the B-axis actuator 114 is mounted on the relatively-low bandwidth Y-axis actuator 104 so as to be movable by the relatively-low bandwidth Y-axis actuator 104, and the C-axis actuator 116 is mounted on the B-axis actuator 114 so as to be movable by the B-axis actuator 114, the relatively-low bandwidth Y-axis actuator 104, or any combination thereof). A workpiece fixture (not shown) may be mechanically coupled to the workpiece positioning assembly 201 (e.g., at the relatively-low bandwidth C-axis actuator 116) to hold, retain, carry, etc., a workpiece (also not shown) in any suitable or desired manner. The workpiece fixture may be provided as one or more chucks or other clamps, clips, or other fastening devices (e.g., bolts, screws, pins, retaining rings, straps, ties, etc.), to which the workpiece can be clamped, fixed, held, secured or be otherwise supported.

The multi-axis machine tool 1400 further includes a tool tip positioning assembly. In the illustrated embodiment, the tool tip positioning assembly is provided as a hybrid tool tip positioning assembly that includes a relatively-low bandwidth X-axis actuator 102 (e.g., provided here as a linear stage oriented along the X-axis), a relatively-low bandwidth Z-axis actuator 106 (e.g., provided here as a stage oriented along the Z-axis) mounted on the relatively-low bandwidth X-axis actuator 102 (e.g., via a fixture 1409 coupled to the relatively-low bandwidth X-axis actuator 102 so as to be movable by the relatively-low bandwidth X-axis actuator 102) and a relatively-high bandwidth Z-axis actuator 112 mounted on the relatively-low bandwidth Z-axis actuator 106 (e.g., so as to be movable by the relatively-low bandwidth Z-axis actuator 106, by the relatively-low bandwidth X-axis actuator 102, or a combination thereof). In an alternative embodiment, the relatively-high bandwidth Z-axis actuator 112 is omitted from the tool tip positioning assembly (i.e., the multi-axis machine tool 1400 does not include the relatively-high bandwidth Z-axis actuator 112).

In addition to the aforementioned components, the hybrid tool tip positioning assembly also includes a relatively-high bandwidth X-axis actuator 108 and a relatively-high bandwidth Y-axis actuator 110. In the illustrated embodiment, the relatively-high bandwidth X-axis actuator 108 and relatively-high bandwidth Y-axis actuator 110 are each provided as a galvanometer-driven mirror systems (e.g., as discussed with respect to FIG. 3) and are incorporated into a common scan head 1410 mounted on the relatively-low bandwidth Z-axis actuator 106 (e.g., so as to be movable by the relatively-low bandwidth Z-axis actuator 106, by the relatively-low bandwidth X-axis actuator 102, or a combination thereof). The scan head 1410 may also include a scan lens (e.g., as discussed above with respect to any of FIG. 3 or 9-11).

The multi-axis machine tool 1400 further includes a process base 1412 and a system base 1414. The process base 1412 is configured to, at least partially, isolate components such as the workpiece positioning assembly 201, laser source 1402, laser optics, etc., from vibrations generated external to the multi-axis machine tool 1400. Accordingly, in one embodiment, the process base 1412 is provided as a relatively heavy block of granite, diabase, or the like or any combination thereof. The process base 1412 is seated on or within the system base 1414, and rests on a set of mounts 1413 (e.g., made from an elastomer material). The mounts 1413 are configured to dampen vibrations generated external to the multi-axis machine tool 1400 (e.g., to prevent or otherwise minimize any degradation in accuracy during processing that would be attributable to such vibrations). The system base 1414 may be supported, for example, on a floor (not shown). In one embodiment, any controllers associated with the actuators, laser source 1402, shutters 1404a, 1404b, etc., of the multi-axis machine tool 1400 may be housed within the system base 1414.

The multi-axis machine tool 1400 further includes a support frame 1416 (e.g., a gantry) 1416 coupled to the process base 1412. The support frame 1416 may be configured to support the tool tip assembly over the workpiece positioning assembly 201. The support frame 1416 may include a pair of supports 1418 coupled to the process base 1412 at opposite sides of the workpiece positioning assembly 201 and commonly supporting a beam 1420. In the illustrated embodiment, relatively-low bandwidth X-axis actuator 102 of the tool tip positioning assembly is coupled to the beam 1420, thereby permitting the support frame 1416 to support the support the tool tip assembly over the workpiece positioning assembly 201. The support frame 1416 may be configured to, at least partially, isolate components, such as the actuators within the aforementioned tool tip positioning assembly, the scan lens, etc., from vibrations generated external to the multi-axis machine tool 1400 as well as from vibrations generated by the workpiece positioning assembly 201. Accordingly, in one embodiment, the supports 1418 and beam 1420 of the support frame 1416 may be formed as a relatively heavy block of granite, diabase, or the like or any combination thereof.

The multi-axis machine tool 1400 further includes an optics wall 1422 coupled to the support frame 1416 (e.g., at the supports 1418 and beam 1420). The optics wall 1422 may support some of the aforementioned laser optics. For example, and as best shown in FIG. 15, laser optics such as the first and second optical shutters 1404a and 1404b, respectively, the first, second, third, fourth, fifth and sixth fold mirrors 1406a, 1406b, 1406c, 1406d, 1406e and 1406f, respectively, and first and second collimators 1408a and 1408b, respectively, may be coupled to the optics wall. In another embodiment, one or both of the first and second shutters 1404a and 1404b, respectively, may be coupled to the process base 1412 in any suitable manner.

Generally, the first, second, third, fourth, fifth, sixth and seventh fold mirrors 1406a, 1406b, 1406c, 1406d, 1406e, 1406f and 1406g, respectively, are arranged on one side of the optics wall 1422 so as to guide laser light (e.g., generated by the laser source 1402, and passed by the first and second optical shutters 1404a and 1404b, respectively) along a propagation path, such as aforementioned propagation path 304, through other laser optics (e.g., the first and second collimators 1408a and 1408b, respectively), and into an optical port 1424 formed in the optics wall 1422. Thus, the propagation path 304 extends from one side of the optics wall 1422 (i.e., a first side of the optics wall 1422, where the laser source 1402 is located), through the optical port 1424, to the other side of the optics wall 1422 (e.g., a second side of the optics wall 1422, where the tool tip positioning assembly is located).

The eighth and ninth fold mirrors 1406h and 1406i, respectively, guide the laser light propagating through the optical port 1424 into the relatively-high bandwidth Z-axis actuator 112. In this case, the eighth fold mirror 1406h can be coupled to the support frame 1416 (e.g., to the beam 1420) via a mirror support beam 1426 such that the orientation and position of the eighth fold mirror 1406h can remain at least substantially fixed during operation of the multi-axis machine tool 1400. The ninth fold mirror 1406i can be coupled to the fixture 1409 such that the orientation and position of the ninth fold mirror 1406i can remain at least substantially fixed during operation of the multi-axis machine tool 1400. Accordingly, the ninth fold mirror 1406i can be moved along the X-axis by the relatively-low bandwidth X-axis actuator 102. As mentioned above, the relatively-low bandwidth Z-axis actuator 106 is coupled to the relatively-low bandwidth X-axis actuator 102 via the fixture 1409. Accordingly, the relatively-high bandwidth Z-axis actuator 112 and the scan head 1410 can move along the Z-axis, relative to the ninth fold mirror 1406i, during operation of the relatively-low bandwidth Z-axis actuator 106.

As exemplarily illustrated, the eighth fold mirror 1406h is aligned to the seventh fold mirror 1406g along the Y-axis, the ninth fold mirror 1406i is aligned to the eighth fold mirror 1406h along the X-axis, and the relatively-high bandwidth Z-axis actuator 112 is aligned to the ninth fold mirror 1406i along the Z-axis. Likewise, the scan head 1410 is aligned to the relatively-high bandwidth Z-axis actuator 112 along the Z-axis. In the alternative embodiment in which the high bandwidth Z-axis actuator 112 is omitted from the tool tip positioning assembly, the scan head 1410 may be aligned to the ninth fold mirror 1406i along the Z-axis.

After laser light is reflected by the ninth fold mirror 1406i, it propagates along the propagation path 304 (optionally, passing through the relatively-high bandwidth Z-axis actuator 112) and enters into the scan head 1410 where it can be deflected by the relatively-high bandwidth X-axis actuator 108 and relatively-high bandwidth Y-axis actuator 110. Thereafter, the laser light is focused by the scan lens in the scan head 1410 before propagating to the workpiece secured to the workpiece positioning assembly 201.

Although the illustrated embodiment contemplates a multi-axis machine tool 1400 having an optical port 1424 in the optics wall 1422, and that the propagation path 304 can extend through the optical port 1424, it will be appreciated that the optics wall 1422 may be configured in any other manner that enables the propagation path 304 to extend from the seventh fold mirror 1406g to the eighth fold mirror 1406h. For example, the optics wall 1422 may include a notch extending from an edge thereof and encompass a region that coincides with the optical port 1424.

Constructed and arranged as described above, fold mirrors such as the eighth and ninth fold mirrors 1406h and 1406i, respectively, provide a free-space beam delivery system to guide the laser light to the scan head 1410 and, optionally, the relatively-high bandwidth Z-axis actuator 112. Because the ninth fold mirror 1406i is mounted to the relatively-low bandwidth X-axis actuator 102, and is aligned to the eighth fold mirror 1406h along the X-axis as well as to the scan head 1410 (and the relatively-high bandwidth Z-axis actuator 112, if included) along the Z-axis, the length and configuration of the propagation path from the eighth fold mirror 1406h to the scan head 1410 can change dynamically during operation of the relatively-low bandwidth X-axis actuator 102 and/or the relatively-low bandwidth Z-axis actuator 106. This can be beneficial compared to certain conventional laser-based multi-axis machine tools that have a fixed beam delivery system, which require the scan head 1410 to be stationary during operation of the laser-based multi-axis machine tool and restrict the size of the workpiece that can be processed by such conventional laser-based multi-axis machine tools. Constructed as described above, through the combined operation of the workpiece positioning assembly 201 and the tool tip positioning assembly, the multi-axis machine tool 1400 can place the tooling region anywhere within a processing volume having maximum dimensions in the X-, Y- and Z-axes of 1000 mm (or less than 1000 mm)×1000 mm (or less than 1000 mm)×750 mm (or less than 500 mm). In one embodiment, the maximum dimension of the processing volume in the X-axis may be equal to or less than 750 mm, 500 mm, 250 mm, 200 mm, 150 mm etc., or between any of these values. In one embodiment, the maximum dimension of the processing volume in the Y-axis may be equal to or less than 750 mm, 500 mm, 250 mm, 200 mm, 150 mm etc., or between any of these values. In one embodiment, the maximum dimension of the processing volume in the Z-axis may be equal to or less than 500 mm, 250 mm, 200 mm, 150 mm etc., or between any of these values. Moreover, and when constructed as described above, laser light can propagate along the propagation path 304 through air in the free-space beam delivery system of the multi-axis machine tool 1400. This can be beneficial compared to certain conventional laser-based multi-axis machine tools that use an optical fiber to deliver laser light to the scan head 1410.

Although the multi-axis machine tool 1400 has been illustrated and described above as including a certain number and arrangement of laser optics such as fold mirrors, shutters and collimators, it will be appreciated that the multi-axis machine tool 1400 may include any different number, type and arrangement of laser optics so long as the aforementioned free-space beam delivery system is preserved.

Although not shown, the multi-axis machine tool 1400 may include a shroud or housing enclosing a space occupied by the laser source 1402 and laser optics such as the first and second optical shutters 1404a and 1404b, respectively, first, second, third, fourth, fifth, sixth and seventh, fold mirrors 1406a, 1406b, 1406c, 1406d, 1406e, 1406f and 1406g, respectively, and first and second collimators 1408a and 1408b, respectively. This shroud (also referred to as an “optics shroud” is coupled to the system base 1414, and may define a portion of the exterior of the multi-axis machine tool 1400. The optics shroud is spaced apart from the optics wall 1422 to prevent movement of the optics shroud (e.g., due to an operator leaning on it) from undesirably affecting the position or alignment of the laser optics attached to the optics wall 1422, or from otherwise undesirably affecting the accuracy with which a workpiece held by the workpiece positioning assembly 201 is processed.

The space enclosed by the optics shroud can also be positively pressurized to prevent particulate matter (e.g., vapors, debris, etc., generated during laser processing of the workpiece) from accumulating on optical surfaces of the laser source and laser optics. Accordingly, the multi-axis machine tool 1400 may include a pump (not shown, but disposed within the space enclosed by the optics shroud and in fluid communication with the environment external to the multi-axis machine tool 1400) to positively pressurize the space enclosed by the optics shroud (e.g., so as to prevent particulate matter such as vapors, debris, etc., generated during laser processing of the workpiece from accumulating on optical surfaces of the laser source 1402 and laser optics).

Although not shown, the multi-axis machine tool 1400 may include a shroud or housing enclosing a space occupied by the and laser optics such as the eighth and ninth fold mirrors 1406h and 1406i, respectively, the tool tip positioning assembly and the workpiece positioning assembly. This shroud (also referred to as a “process shroud” is coupled to the system base 1414 and the optics shroud, and may define another portion of the exterior of the multi-axis machine tool 1400. The process shroud is spaced apart from the optics wall 1422 to prevent movement of the process shroud (e.g., due to an operator leaning on it) from undesirably affecting the position or alignment of the laser optics attached to the optics wall 1422, or from otherwise undesirably affecting the accuracy with which a workpiece held by the workpiece positioning assembly 201 is processed. Generally, the process shroud is configured to prevent (or at least substantially prevent) particulate matter generated during laser processing of the workpiece from exiting the space enclosed by the process shroud into the environment exterior to the multi-axis machine tool 1400.

### IX. Embodiments Concerning Management of Thermal Issues

Although not shown, the multi-axis machine tool 1400 may include a chiller or other device configured to prevent the laser source 1402 from undesirably overheating during its operation. During operation, components such as the laser source 1402, pump, chiller, or the like, can generate heat. In some cases, the heat generated can diffuse through components of the multi-axis machine tool 1400 such as the optics wall 1422, the support frame 1416 (e.g., the supports 1418 and/or the beam 1420), the relatively-low bandwidth X-axis actuator 102, etc., into the space enclosed by the process shroud. It has been discovered that, in some cases, the heat diffused into the space enclosed by the process shroud can be sufficient to induce thermal expansion of the relatively-low bandwidth X-axis actuator 102. In general, however, thermal expansion of the relatively-low bandwidth X-axis actuator 102 can be induced as a result of changes in ambient temperature as low as 7° F.

As mentioned above, in the multi-axis machine tool 1400, the relatively-low bandwidth X-axis actuator 102 is provided as a linear stage oriented along the X-axis. The linear stage typically includes a bed (e.g., formed of a material such as aluminum or an aluminum alloy), a track rail attached to the bed, and a carriage moveably mounted to the track rail. Typically, the linear stage is mounted to the beam 1420 by fixing the bed to the beam 1420 (e.g., using a plurality of screws, bolts, pins, or the like or any combination thereof). Formed of a material such as aluminum or aluminum alloy, the bed of the linear stage has a relatively high coefficient of thermal expansion (CTE) compared to that of the beam 1420, which is typically formed of granite. For example, the CTE of the bed is about 12×10⁻⁶/° F. while the CTE of the beam 1420 is about 3×10⁻⁶/° F. Due to the difference in CTE between the bed of the linear stage and the beam 1420, the when the linear stage is attached to the beam 1420, the bed can bow, warp or otherwise deform undesirably (e.g., if an excessive amount of heat diffuses into the relatively-low bandwidth X-axis actuator 102).

Numerous techniques may be implemented to minimize or otherwise prevent the undesirable deformation of the relatively-low bandwidth X-axis actuator 102. In one embodiment, the multi-axis machine tool 1400 may be operated in an environment in which the ambient temperature of the environment is equal to (or substantially equal to) the temperature of the environment in which the multi-axis machine tool 1400 was assembled. In another embodiment, the multi-axis machine tool 1400 may include a heating unit configured to heat the space enclosed by the process shroud (e.g., so that the ambient temperature of the space enclosed by the process shroud is at least substantially equal to the ambient temperature of the space enclosed by the optics shroud). In another embodiment, the multi-axis machine tool 1400 may include a cooling unit configured to cool the space enclosed by the optics shroud (e.g., so that the ambient temperature of the space enclosed by the optics shroud is at least substantially equal to the ambient temperature of the space enclosed by the process shroud). In yet another embodiment, the optics wall 1422 may be formed of a material (e.g., aluminum or aluminum alloy) that has the same or similar CTE as that of the relatively-low bandwidth X-axis actuator 102, and may be sized (e.g., in terms of thickness, height, length, etc.) to have a similar moment of inertia as the relatively-low bandwidth X-axis actuator 102 (or the bed thereof). Configured as described above, the optics wall 1422 can effectively counteract any thermally-induced deformation that may occur in the relatively-low bandwidth X-axis actuator 102 (e.g., due, in part, to the fact that the optics wall 1422 is coupled to a side of the beam 1420 that is opposite the relatively-low bandwidth X-axis actuator 102).

In another embodiment, the undesirable bowing or deformation of the relatively-low bandwidth X-axis actuator 102 may be minimized or otherwise prevented, by providing the multi-axis machine tool 1400 with a duct system that transfers a portion of the heated gas within the space enclosed by the optics shroud into the space enclosed by the process shroud.

### X. Embodiments Concerning Management of Particulate Matter

As mentioned above, particulate matter (e.g., vapors, debris, etc.), may be generated during laser processing of the workpiece) can be generated during processing of the workpiece using a tool such as a beam of laser light. To prevent or otherwise minimize the amount of particulate matter from undesirably accumulating on surfaces (e.g., on the surface of a scan head such as scan head 1410, on the surface of a mirror such as eighth or ninth fold mirror 1406h or 1406i, etc.) or from undesirably exiting the multi-axis machine tool (e.g., through the process shroud of the multi-axis machine tool 1400), etc., the machine tool may include a capture-nozzle coupled to the workpiece positioning assembly. The capture nozzle may be in fluid communication with a vacuum source and have an inlet configured to receive the particulate matter. In one embodiment, the inlet is positioned close to the workpiece where the tooling region is created during processing. Accordingly, the capture nozzle may be connected to the same stage to which the workpiece is ultimately fixtured. For example, if the workpiece is coupled to the C-axis actuator 116 (e.g., by a fixture such as a chuck, etc.), then the capture nozzle may also be coupled to the C-axis actuator 116 so that the inlet of the capture nozzle can move with the workpiece during processing.

In addition to the capture nozzle, the multi-axis machine tool can, optionally, include a gas-flow injection nozzle arranged on the opposite size of the workpiece from the capture nozzle and, for example, coupled to the same stage as the stage to which the capture nozzle is coupled (e.g., so that the gas-flow injection nozzle can move with the capture nozzle and workpiece during processing). Generally, the gas-flow injection nozzle is coupled to a source of high-pressure gas, and is configured to direct the high-pressure gas to the tooling region during processing.

### XI. Conclusion

The foregoing is illustrative of embodiments and examples of the invention, and is not to be construed as limiting thereof. Although a few specific embodiments and examples have been described with reference to the drawings, those skilled in the art will readily appreciate that many modifications to the disclosed embodiments and examples, as well as other embodiments, are possible without materially departing from the novel teachings and advantages of the invention. Accordingly, all such modifications are intended to be included within the scope of the invention as defined in the claims. For example, skilled persons will appreciate that the subject matter of any sentence, paragraph, example or embodiment can be combined with subject matter of some or all of the other sentences, paragraphs, examples or embodiments, except where such combinations are mutually exclusive. The scope of the present invention should, therefore, be determined by the following claims, with equivalents of the claims to be included therein.

What is claimed is:

1. A laser-based multi-axis machine tool for processing a workpiece, comprising:
a laser source configured to generate the laser light, the laser light propagatable along a propagation path to illuminate the workpiece at a spot;
a workpiece positioning assembly operative to move the workpiece;
a tool tip positioning assembly operative to move the spot; and
a controller operatively coupled to the workpiece positioning assembly and the tool tip positioning assembly, wherein the controller is operative to control an operation of at least one selected from the group consisting of the workpiece positioning assembly and the tool tip positioning assembly to cause relative movement between the workpiece and the spot along a tool path in at least three axes, wherein the controller includes a error correction system operative to detect and compensate for deviations of the tool path from a desired trajectory.

2. The laser-based multi-axis machine tool of claim 1, wherein one or more relatively high-bandwidth actuators is used to compensate for tracking errors associated with one or more relatively low-bandwidth actuators.

3. The laser-based multi-axis machine tool of claim 1, wherein the error correction system is operative to:
process a set of preliminary actuator commands to generate a first set of intermediate linear actuator commands;
output the preliminary actuator commands to respective rotary actuators that generate and output corresponding feedback signals to each of the respective linear and rotary actuators; and
process the first set of intermediate linear actuator commands with and the rotary feedback signals to generate a second set of intermediate linear actuator commands.

4. The error correction system of claim 3, wherein the error correction system is further operative to:
compute the difference between ones of the respective preliminary linear actuator commands and ones of the respective second set of intermediate linear actuator commands to derive a set of first linear error signals;
compute the difference between a position commanded by each respective actuator command output to each respective actuator and a position indicated by the feedback signal generated by the respective actuator to derive a set of second linear error signals; and
combine each of the first linear error signals with a corresponding second linear error signal and output each of a combined first and second linear error signal to a corresponding relatively high bandwidth actuators as a set of processed linear actuator commands.

5. The laser-based multi-axis machine tool of claim 1, wherein one or more of the relatively high-bandwidth actuators is a galvanometer.

6. A controller operative to:
control an operation of at least one selected from the group consisting of a workpiece positioning assembly and a tool tip positioning assembly to cause relative movement between a workpiece and a spot along a tool path in at least three axes,
wherein the controller includes a error correction system operative to detect and compensate for deviations of the tool path from a desired trajectory.

7. The controller of claim 6, wherein the error correction system is operative to control an operation of one or more relatively high-bandwidth actuators to compensate for tracking errors associated with one or more relatively low-bandwidth actuators.

8. The controller of claim 7, wherein the error correction system is operative to:
process a set of preliminary actuator commands to generate a first set of intermediate linear actuator commands;
output the set of preliminary actuator commands to respective rotary actuators that generate and output corresponding feedback signals to each of the respective linear and rotary actuators; and
process the first set of intermediate linear actuator commands with and the rotary feedback signals to generate a second set of intermediate linear actuator commands.

9. The controller of claim 8, wherein the error correction system is further operative to:
compute the difference between ones of the respective preliminary linear actuator commands and ones of the respective second set of intermediate linear actuator commands to derive a set of first linear error signals;
compute the difference between a position commanded by each respective actuator command output to each respective actuator and a position indicated by the feedback signal generated by the respective actuator to derive a set of second linear error signals; and
combine each of the first linear error signals with a corresponding second linear error signal and output each of a combined first and second linear error signal to a corresponding relatively high bandwidth actuators as a set of processed linear actuator commands.

10. A non-transitory computer-readable medium for use with a controller for a laser system for machining a workpiece, wherein the non-transitory computer-readable medium has instructions stored thereon which, when executed by the controller, cause the controller to:
control an operation of at least one selected from the group consisting of a workpiece positioning assembly and a tool tip positioning assembly to cause relative movement between a workpiece and a spot along a tool path in at least three axes,
wherein the controller includes a error correction system operative to detect and compensate for deviations of the tool path from a desired trajectory.

11. The non-transitory computer-readable medium of claim 10, wherein the instructions stored, when executed by the controller, cause the controller to control an operation of one or more relatively high-bandwidth actuators to compensate for tracking errors associated with one or more relatively low-bandwidth actuators.

12. The non-transitory computer-readable medium of claim 11, wherein the controller is operative to:
process a set of preliminary actuator commands to generate a first set of intermediate linear actuator commands;
output the set of preliminary actuator commands to respective rotary actuators that generate and output corresponding feedback signals to each of the respective linear and rotary actuators; and
process the first set of intermediate linear actuator commands with and the rotary feedback signals to generate a second set of intermediate linear actuator commands.

13. The controller of claim 12, wherein the controller is further operative to:
compute the difference between ones of the respective preliminary linear actuator commands and ones of the respective second set of intermediate linear actuator commands to derive a set of first linear error signals;
compute the difference between a position commanded by each respective actuator command output to each respective actuator and a position indicated by the feedback signal generated by the respective actuator to derive a set of second linear error signals; and
combine each of the first linear error signals with a corresponding second linear error signal and output each of a combined first and second linear error signal to a corresponding relatively high bandwidth actuators as a set of processed linear actuator commands.
